(19) United States
(12) Patent Application Publication
(10) Pub. No.: US 2025/0389138 A1
(43) Pub. Date: Dec. 25, 2025

(54) APPARATUS AND METHOD FOR AGE-GATING ORAL NICOTINE CANS

(71) Applicant: SkyX IP Holdings I LLC, New York, NY (US)

(72) Inventors: Martin Steinbauer, New York, NY (US); Warren Huffman, New York, NY (US); Jeffrey Chagnon, New York, NY (US)

(73) Assignee: SkyX IP Holdings I LLC, New York, NY (US)

(21) Appl. No.: 19/206,297

(22) Filed: May 13, 2025

Related U.S. Application Data
(60) Provisional application No. 63/661,625, filed on Jun. 19, 2024.
(60) Provisional application No. 63/793,597, filed on Apr. 23, 2025.

(51) Int. Cl. E05B 51/00; B65D 55/02

(52) U.S. Cl. CPC E05B 51/005; B65D 55/02

(57) ABSTRACT

A can, system, and method for storing oral nicotine dosage forms and age-gating or otherwise controlling access to such dosage forms, the can including a locking mechanism, a shape memory component, a radiofrequency component, and a shape memory component actuator. The shape memory component includes a second shape which maintains the lid of the can in a locked state and first shape which allows for removal of the lid or other unlocking of the can. The radiofrequency component is connected to the actuator that controls the shape memory component, allowing for unlocking of the can based on a signal received by the radiofrequency component.

### CROSS-REFERENCE TO RELATED APPLICATIONS

This application claims the benefit of priority of U.S. Provisional Patent Application Ser. No. 63/661,625, filed on Jun. 19, 2024, and titled “ORAL NICOTINE DISPENSING SYSTEM,” and claims the benefit of priority of U.S. Provisional Patent Application Ser. No. 63/793,597, filed on Apr. 23, 2025, and titled “APPARATUS AND METHOD FOR AGE-GATING ORAL NICOTINE CANS,” both of which are incorporated by reference herein in their entirety.

### BACKGROUND

The issue of youth access to nicotine products is a pressing concern for regulatory bodies and public health organizations worldwide. Nicotine products, particularly those with flavors or high nicotine content, are often appealing to younger demographics, leading to increased rates of initiation and addiction among youth. This poses a significant public health risk, as early exposure to nicotine can have long-term detrimental effects on brain development and health.

At the same time, preserving access to tobacco-free nicotine products for adults is an important tool in smoking and tobacco cessation and reduction. Cessation and reduction of adult tobacco use is crucial for improving both individual and public health. It significantly reduces the risk of developing various diseases, including cardiovascular disease, chronic obstructive pulmonary disease (COPD), stroke, and several types of cancer, particularly lung cancer. Furthermore, tobacco cessation contributes to better quality of life, as individuals experience improved physical fitness, better taste and smell, and improved respiratory function. On a broader scale, smoking cessation reduces healthcare costs associated with treating smoking-related diseases, helps improve air quality, and reduces exposure to secondhand smoke, which can be harmful to non-smokers, especially children and pregnant women.

Accordingly, solutions are needed which prevent youth access to nicotine products, while preserving easy and low-friction access for adult consumers, in order to facilitate tobacco or smoking cessation. Such need is especially pressing with respect to oral (tobacco-free) nicotine products, which are rising in popularity as a tobacco alternative for adults, but may pose a significant risk to youth given the relative ease of social sharing and inconspicuous profile of such dosage forms.

While oral nicotine dosage forms are typically stored and distributed in cans, no effective method or apparatus for age-gating of such cans is currently available. There is a need for devices and methods of providing selective (e.g., age restricted) access to these existing forms of packaging.

### BRIEF SUMMARY

Provided herein are devices, systems, and methods which provide selective user access to cans containing dosage forms such as oral nicotine dosage forms. Preferably, such selective access may include age-gating to prevent unauthorized youth access. Specifically, in some aspects, the disclosed devices, systems, and methods are directed to securing the packaging of oral nicotine dosage forms, such as pouches, films, lozenges, gum, oral pouch-less products (non-dissolvable), pearls, oral patches, tablets, and other product formats, currently being packaged in cans.

The present disclosure provides devices, systems, and methods which allow for unlocking of cans at the point-of-sale. In some preferred aspects, this may be a one-time unlock system. In other aspects, this system may allow the authorized consumer to initiate a relock, e.g., for situations when young children share a household with the authorized consumer. Accordingly, the disclosed devices and systems may be fitted with a locking mechanism which can be unlocked at point-of-sale for an authorized (e.g., of legal age) consumer. According to some embodiments, the disclosed locking mechanisms may contain a shape memory component which changes state when energy is applied to it. This state change may allow the locking mechanism to convert from a locked to an unlocked state.

According to some aspects, the necessary state change in the shape memory component may be powered by energy provided by an external device, such as a near-field communication (NFC) reader, a radio frequency identification (RFID) reader, or a device adapted to provide electrical, magnetic, or acoustic energy.

According to some aspects, the disclosed cans for storage of oral nicotine dosage forms include: a base and a lid, together defining a storage cavity; a locking mechanism comprising a shape memory component having a first shape and a second shape, wherein the shape memory component is configured to maintain the can in a locked state in the second shape and to convert the can into an unlocked state in the first shape; an NFC tag; a shape memory component actuator electrically connected to the NFC tag and to the shape memory component. Such cans may be used in any of the systems or in performance of any of the methods disclosed herein. In such cans, the shape memory component may also be replaced or used in addition to a magnetic component, a mechanical locking component, a pressurized locking component, a hydrogel component, or any other locking component or mechanism disclosed herein.

According to some aspects, the disclosed method include methods for age-gating of oral nicotine dosage forms, including: authenticating a user by collecting a user metadata, comparing the user metadata to a control data, and determining a positive or negative authentication result based on the comparison; and unlocking a can containing the oral nicotine dosage forms if the authentication result is positive, or declining to unlock a can, if the authentication result is negative. Such methods may be performed by using any of the embodiments of cans disclosed herein.

According to some aspects, the disclose systems include a can system, including any of the can embodiments disclosed herein, and a plurality of dosage forms disposed within the storage cavity.

According to some aspects, the disclosed systems include systems for providing selective access, e.g., age-gating, to oral nicotine dosage forms, including: any one or more of the disclosed embodiments of cans; any one or more the disclosed external devices; a processor; and a memory communicatively connected to the processor, wherein the memory contains instructions configuring the processor to collect a user metadata, compare the user metadata to a control data, determine a positive or negative authentication result based on the comparison, and send an unlocking signal to the can containing the oral nicotine dosage forms if the authentication result is positive.

### Terms and Definitions

As used herein, “antenna” refers to a device configured to convert voltage from a transmitter into a radio signal or vice versa.

As used herein, “base” refers to the portion of a container which forms a closed, three-dimensional hollow container for holding or containing dosage forms, when used in conjunction with a lid. A “base,” as used herein, generally has a bottom surface and a continuous wall connected to the bottom surface of the base along its circumference. As used herein, “bottom” refers a surface or side, e.g., of a can, which would normally rest stably on a surface when the object in question set down. In many cases, the “bottom” side or surface will be an opposite side or surface from that formed by a lid of the can. As used herein, “lid” refers to an upper portion of a container, which is designed to fit securely together with the base, to form a closed three-dimensional hollow container for holding or containing dosage forms. While the base typically forms at least two sides of the container, the lid typically forms only one side of the container.

As used herein, “can” refers to a container, canister, box, vessel, or other packaging form, having a continuous body defined by a base and a lid, defining a storage cavity. The term “can” does not limit or restrict the type of material which may form the body or any other part of the can. A “storage cavity” refers to the three-dimensional hollow space within a can, configured to store items, e.g., dosage forms, or in particular, oral nicotine dosage forms.

As used herein, “communicatively connected” refers to being connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

As used herein, “electrochromic material” refers to a type of material that changes its optical properties, such as color or transparency, and/or its shape, in response to an applied electric voltage. This change is reversible, enabling applications such as smart windows, displays, and electronic paper, where controlling the light transmission or reflection is desirable.

As used herein, “NFC” refers to near field communication. “Near field communication chip” refers to a small microchip or electronic device that can store data and enables wireless communication via radio waves over short distances, typically less than 10 centimeters, and no more than 20 cm. An “NFC tag” refers to a small electronic device including an NFC chip and an antenna.

As used herein, “oral nicotine dosage forms” refers to forms of nicotine delivery designed for administration through the oral cavity. These can include products such as nicotine pouches, films, lozenges, gum, oral pouch-less products (non-dissolvable), pearls, oral patches, and tablets, which release nicotine to be absorbed through the mucous membranes in the mouth. As used herein, “oral nicotine dosage forms” do not include inhaled forms of nicotine delivery.

As used herein, “RFID” refers to radio frequency identification. An “RFID chip” or “radio frequency identification chip” refers to a small electronic device or microchip that can store data and can be used for wireless communication via radio waves at ranges extending up to 25 meters, or up to 100 meters. An “RFID tag” refers to a small electronic device including an RFID chip and an antenna.

As used herein, a “shape memory material” refers to a material which can be deformed into a second shape from first shape and reverts to the first shape when sufficient energy is applied, e.g., in the form of heat, electricity, sound or radio waves, and/or a magnetic field. A “first shape” refers to the initial shape of a shape memory alloy or material, which is recovered after deformation. A “second shape” refers to a shape which a shape memory alloy or material is deformed to, which it abandons to return to its initial (or “first”) shape when energy is applied.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a can equipped with a locking mechanism, in accordance with one disclosed embodiment.

FIG. 1B illustrates a base for a can equipped with a locking mechanism, in accordance with one disclosed embodiment.

FIG. 1C illustrates a can equipped with a locking mechanism, in accordance with one disclosed embodiment.

FIG. 1D illustrates a base for a can equipped with a locking mechanism, in accordance with one disclosed embodiment.

FIG. 2 illustrates a base for a can equipped with a locking mechanism, in accordance with one disclosed embodiment.

FIG. 3A illustrates a can equipped with a locking mechanism, in accordance with one disclosed embodiment.

FIG. 3B illustrates a can equipped with a locking mechanism, in accordance with one disclosed embodiment.

FIG. 3C illustrates a can equipped with a locking mechanism, in accordance with one disclosed embodiment.

FIG. 3D illustrates a can equipped with a locking mechanism, in accordance with one disclosed embodiment.

FIG. 3E illustrates a can equipped with a locking mechanism, in accordance with one disclosed embodiment.

FIG. 3F illustrates a can equipped with a locking mechanism, in accordance with one disclosed embodiment.

FIG. 3G illustrates a can equipped with a locking mechanism, in accordance with one disclosed embodiment.

FIG. 3H illustrates a can equipped with a locking mechanism, in accordance with one disclosed embodiment.

FIG. 4A illustrates a can equipped with a locking mechanism, in accordance with one disclosed embodiment.

FIG. 4B illustrates a can equipped with a locking mechanism, in accordance with one disclosed embodiment.

FIG. 4C illustrates a can equipped with a locking mechanism, in accordance with one disclosed embodiment.

FIG. 5A illustrates a can equipped with a locking mechanism, in accordance with one disclosed embodiment.

FIG. 5B illustrates a can equipped with a locking mechanism, in accordance with one disclosed embodiment.

FIG. 5C illustrates a can equipped with a locking mechanism, in accordance with one disclosed embodiment.

FIG. 6A illustrates a can equipped with a locking mechanism, in accordance with one disclosed embodiment.

FIG. 6B illustrates a can equipped with a locking mechanism, in accordance with one disclosed embodiment.

FIG. 6C illustrates a can equipped with a locking mechanism, in accordance with one disclosed embodiment.

FIG. 6D illustrates a can equipped with a locking mechanism, in accordance with one disclosed embodiment.

FIG. 6E illustrates a can equipped with a locking mechanism, in accordance with one disclosed embodiment.

FIG. 7A illustrates a lid for a can equipped with a locking mechanism, in accordance with one disclosed embodiment.

FIG. 7B illustrates a lid for a can equipped with a locking mechanism, in accordance with one disclosed embodiment.

FIG. 7C illustrates a can equipped with a locking mechanism, in accordance with one disclosed embodiment.

FIG. 7D illustrates a can equipped with a locking mechanism, in accordance with one disclosed embodiment.

FIG. 8A illustrates a can equipped with a locking mechanism, in accordance with one disclosed embodiment.

FIG. 8B illustrates a can equipped with a locking mechanism, in accordance with one disclosed embodiment.

FIG. 8C illustrates a can equipped with a locking mechanism, in accordance with one disclosed embodiment.

FIG. 8D illustrates a can equipped with a locking mechanism, in accordance with one disclosed embodiment.

FIG. 9A illustrates a lid for a can equipped with a locking mechanism, in accordance with one disclosed embodiment.

FIG. 9B illustrates a base for a can equipped with a locking mechanism, in accordance with one disclosed embodiment.

FIG. 10A illustrates a lid for a can equipped with a locking mechanism, in accordance with one disclosed embodiment.

FIG. 10B illustrates a base for a can equipped with a locking mechanism, in accordance with one disclosed embodiment.

FIG. 11A illustrates components of a can equipped with a locking mechanism, in accordance with one disclosed embodiment.

FIG. 11B illustrates components of a can equipped with a locking mechanism, in accordance with one disclosed embodiment.

FIG. 12A illustrates components of a can equipped with a locking mechanism, in accordance with one disclosed embodiment.

FIG. 12B illustrates components of a can equipped with a locking mechanism, in accordance with one disclosed embodiment.

FIG. 12C illustrates components of a can equipped with a locking mechanism, in accordance with one disclosed embodiment.

FIG. 13A illustrates components of a can equipped with a locking mechanism, in accordance with one disclosed embodiment.

FIG. 13B illustrates components of a can equipped with a locking mechanism, in accordance with one disclosed embodiment.

FIG. 14A illustrates components of a can equipped with a locking mechanism, in accordance with one disclosed embodiment.

FIG. 14B illustrates components of a can equipped with a locking mechanism, in accordance with one disclosed embodiment.

FIG. 15A illustrates an external device, in accordance with one disclosed embodiment.

FIG. 15B illustrates a can equipped with a locking mechanism and an external device, in accordance with one disclosed embodiment.

FIG. 16A illustrates a can equipped with a locking mechanism and an external device, in accordance with one disclosed embodiment.

FIG. 16B illustrates a can equipped with a locking mechanism and an external device, in accordance with one disclosed embodiment.

FIG. 16C illustrates a can equipped with a locking mechanism and an external device, in accordance with one disclosed embodiment.

FIG. 16D illustrates a can equipped with a locking mechanism and an external device, in accordance with one disclosed embodiment.

FIG. 16E illustrates a can equipped with a locking mechanism and an external device, in accordance with one disclosed embodiment.

FIG. 17A illustrates a can equipped with a locking mechanism and an external device, in accordance with one disclosed embodiment.

FIG. 17B illustrates a can equipped with a locking mechanism and an external device, in accordance with one disclosed embodiment.

FIG. 18A illustrates an external device, in accordance with one disclosed embodiment.

FIG. 18B illustrates a can equipped with a locking mechanism and an external device, in accordance with one disclosed embodiment.

FIG. 18C illustrates a can equipped with a locking mechanism and an external device, in accordance with one disclosed embodiment.

FIG. 19 illustrates a computing device, in accordance with one disclosed embodiment.

FIG. 20 illustrates a system and method for unlocking a can, in accordance with one disclosed embodiment.

### DETAILED DESCRIPTION

Provided herein are devices, systems, and methods which provide selective user access to cans containing dosage forms such as oral nicotine dosage forms including nicotine pouches, oral nicotine films, lozenges, gum, and oral pouch-less products (non-dissolvable). Preferably, such selective access may include age-gating to prevent youth access while maintaining accessibility of such tobacco-free dosage forms for adult users, and particularly for adult users engaged in smoking and tobacco cessation efforts.

The present disclosure provides devices, systems, and methods which allow for unlocking of cans at the point-of-sale. In some preferred aspects, this may be a one-time unlock system. Accordingly, the disclosed devices and systems may be fitted with a locking mechanism which can be unlocked at point-of-sale for an authorized (e.g., of legal age) consumer. The disclosed locking mechanisms may contain a shape memory component including a shape memory material which changes state when energy is applied to it. This state change may allow the locking mechanism to convert from a locked to an unlocked state.

According to some aspects, the necessary state change in the shape memory material may be powered by energy provided by a near-field communication (NFC) reader or radio frequency identification (RFID) beacon. More specifically, the necessary energy may be provided to the shape memory component via an NFC/RFID chip, an antenna (to improve reception of the radio frequency signal, especially in the case of metal cans which would otherwise interfere with the radio signal), a PCB, a capacitor, a transistor, and a transducer, provided on or integrated into the can. Such a chip/energy storage mechanism may allow enough energy to be provided induce a state change in the shape memory component which allows for unlocking of the can.

### Cans

The disclosed devices, systems, and methods provide for securing, locking, and unlocking of cans. As previously noted, “can” refers to a container, canister, box, vessel, or other packaging form, having a continuous body defined by a base and a lid, defining a storage cavity. The disclosed cans may be formed in various shapes, including a cylindrical shape, a rectangular shape, a cube shape, an oblong shape, and oval or pill shape, and pyramid shape, or any other three-dimensional, hollow shape suitable for storing dosage forms therein. In a preferred embodiment, the can has a cylindrical shape, according to typical, conventional cans used for storing oral nicotine dosage forms such as pouches. According to some aspects, the lid may form only one side of the can's shape, with the base defining the remaining sides of the shape. For example, in a cylindrical embodiment, the lid may form one circular end of the cylinder while the base forms both the opposing circular end as well as the height of the cylinder. According to some aspects, the disclosed cans may have bottom surface configured to rest stably on a surface when the can is set down. In some embodiments, the bottom surface may be a surface opposite the lid. For example, in a cylindrical embodiment, the bottom surface may be the circular end of the cylinder which is opposite the base of the cylinder formed by the lid.

In some embodiments, in an unlocked state, the lid of the can may be entirely removable from the base, while in alternative embodiments, only a portion of the lid may be removable or openable in an unlocked state. For example, a portion of the lid may form a partial opening mechanism such as a flap, window, door, tab, hatch, aperture, a rotating or sliding window configured to rotate within a single plane in order to provide an opening, or any other suitable opening means which may open in an unlocked state to allow for access to dosage forms within the storage cavity, while the remainder of the lid remains attached to the base. In some embodiments, the partial opening mechanism may be disposed in other areas of the can, such as on a portion of the base, including on a bottom surface or on a sidewall. According to some aspects, the lid or other portions of the can may include a hatch having a first end attached to the lid and a second end which is configured to detach from the lid and open, when the can is unlocked. The first end of the hatch may be attached to the lid via one or more of a hinge, a flexible seam, a sliding joint, a rotational joint, or the like. According to some embodiments, the flexible seam may be formed by making the thickness of the material small enough to allow for it to be flexible or by using a different material from the remainder of the lid or the can (for instance, by using polypropylene when the can is made of PCTG). In some instances, the flexible seam may be formed of the same material as adjacent areas of the lid and/of the can, but may have a smaller thickness than the adjacent areas, thereby allowing for bending. While in some embodiments, the opening mechanism may be formed of the same material as adjacent portions of the can, in other embodiments, the opening mechanism may be formed of a different material. According to some embodiments, the seam material may have a lower elastic modulus or a higher bendability than the surrounding material of the lid and/or the can. In certain exemplary embodiments, the opening mechanism such as the hatch, and/or the flexible seam may be formed by or include a shape memory material, e.g., a shape memory alloy (SMA).

In some embodiments, the disclosed cans may be metal cans. For example, the disclosed cans may include or may be made entirely or largely out of a metal. For example, the can may be at least 80%, at least 90%, at least 95%, or at least 98% by weight metal. The metal may include one or more of aluminum, tinplate (steel with a thin layer of tin), chromed steel (steel with a thin layer of chromium), stainless steel, zinc, copper, or the like. According to some alternative embodiments, the disclosed cans may be entirely or largely out of a plastic. For example, the can may be at least 80%, at least 90%, at least 95&, or at least 98% by weight plastic. The plastic may include one or of polypropylene (PP), polyethylene terephthalate (PET), high-density polyethylene (HDPE), low-density polyethylene (LDPE), polyvinyl chloride (PVC), polystyrene (PS), polylactic acid (PLA), Ethylene Vinyl Alcohol (EVOH), polycarbonate (PC), PCTG, or the like.

In some embodiments, the cans may be designed to be disposable, consistent with conventional cans for oral nicotine dosage forms such as pouches. In such embodiments, as well as in other instances, it may be advantageous for the cans to contain or be entirely made from a cost-effective metal such as aluminum. In some embodiments, it may also be desirable for the cans to contain or be made entirely out of biodegradable or compostable materials. A biodegradable or compostable material may be a material which decomposes in 6 months or less, 1 year or less, 2 years or less, 5 years or less, 10 years or less, 20 years or less, 50 years or less, or 100 years or less when exposed to natural conditions including one or more of moisture, soil, microbes, heat, and the like, or to industrial composting conditions. Such materials may include a biodegradable or compostable plastic. In an embodiment, the plastic may include eco-friendly, biodegradable, or otherwise compostable plastic. In a non-limiting example, such plastic may include a plant-based plastic such as polylactic acid (PLA), polyhydroalkanoates (PHAs), polyhydroxy butyrate (PHB), polyhdroxyvalerate (PHV), polyhydroxy hexanoate (PHH), and the like. In another non-limiting example, such plastic may also include petroleum-based plastics such as polyglycolic acid (PGA), polybutylene succinate (PBS), polycaprolactone (PCL), polybutylene adipate terephthalate (PBAT), Oxo-degradable polypropylene (oxo-PP), and the like.

In some cases, and particularly in embodiments where cans employ biodegradable and/or compostable materials, there may be concern about potential leachables and/or extractables and/or early decomposition of the cans. To mitigate this concern, in some embodiments, the disclosed cans may include an interior coating applied to a portion of or entirely covering the surface of the storage cavity. Such a coating may comprise one or more of epoxy coatings including one or more of AP4, AP6, Epoxy-1, Bisphenal A diglycidyl ether (DBEBA), or BPA-free epoxy coatings; polyethylene; polypropylene; polyvinyl; wax; or aluminum. The composition and thickness of the interior coating may be chosen to prevent leaching, migration, or other loss of known extractables/leachables from the interior of the storage cavity and/or from the dosage forms stored therein. The interior coating may also have additional benefits such as providing a barrier to oxygen, light, moisture, and the like. According to some exemplary embodiments, the interior coating may have a thickness of less than 0.015 mm, between 0.015 mm to 0.03 mm, between 0.03 mm and 0.04 mm, between 0.04 mm and 0.05 mm, and thicker than 0.05 mm. For instance, epoxy coatings can be effective in the range of 0.02 mm to 0.04 mm, whereas polyester coatings may be thinner at 0.015 mm to 0.03 mm. It is important to select an appropriate thickness for the coating, e.g., as disclosed herein, because too small a thickness may be insufficient to protect from leachables or insufficient to satisfy regulatory standards on safety. While thicker coatings protect more thoroughly from potential leachables, they come at an increased cost and may impact the biodegradable/compostable timeline of the material.

According to some embodiments, the disclosed cans may include pieces (e.g., seals, flexible seams) requiring more elasticity than a typical metal or plastic. To the extent feasible, such pieces may also be made of a biodegradable or compostable material, such as one or more of the aforementioned materials, so long as such material can provide the required elasticity. In alternative embodiments, such pieces may include or be formed from silicone, either alone or in combination with one or more of the aforementioned compostable or biodegradable materials.

The disclosed cans may be formed through any known suitable manufacturing method, such as injection molding, compression molding, rotational molding, vacuum casting, blow molding, additive manufacturing, or similar. In one exemplary embodiment, a method of manufacturing the disclosed cans may include using an injection molding process, where the injection molding process may involve the use of an injectable mold configured to create specific shapes and features. In some embodiments, the injectable mold may include two halves that are clamped together, with one or more cavities in between, such that the cavities may define the shape of the component. In some cases, material such as, without limitation, BIOGRADE B-M (i.e., a blend of thermoplastic starch (TPS), aliphatic polyesters (AP) and natural plasticizers (glycerol and sorbitol)) may be injected into the injectable mold under high pressure, filling the space and taking on the shape of injectable mold. Other exemplary materials may include, without limitation, BIOPAR FG MO (i.e., a bio-plastic resin consisting mainly of thermoplastic potato starch, biodegradable synthetic copolyesters and additives), BIOPLAST (i.e., a new kind of plasticizer thermoplastic material), ENSO RENEW RTP (i.e., a renewable, biodegradable, compostable and economic thermoplastic), and/or the like. The injection molding process may include a cooling process effective to cool and/or solidify injected material. The injectable mold may be then opened and the finished component may be removed. In some cases, the injectable mold may be precisely machined to the desired shape and size of the component. The disclosed injection molding processes may be used to manufacture one or more of the lid, the base, and/or other components of the disclosed cans.

### Locking Mechanism

The disclosed cans are fitted with a locking mechanism that prevents access to the storage cavity and/or to a dosage form stored therein in a locked state and allows for access to the storage cavity and/or a dosage form stored therein in an unlocked state. Access to the storage cavity and stored dosage forms may be provided by partial or full removal of the lid, opening of a portion of the lid or the base, such as a flap, window, door, tab, hatch, or aperture, rotating or sliding window, or other methods effective to provide access to dosage forms within the storage cavity.

The disclosed locking mechanism may include at least one of a shape memory material component, a magnetic component, a mechanical component, or pressurized component.

According to some aspects, the locking mechanism may include a shape memory material component, including a shape memory material. As previously noted, a “shape memory material” refers to a material which can be deformed into a second shape from first shape and reverts to the first shape when sufficient energy is applied, e.g., in the form of heat, electricity, sound or radio waves, and/or a magnetic field. In some instances, the shape memory material may have a transformation temperature at which the material undergoes a change in state from a second to a first shape. For example, when the shape memory material receives sufficient energy to be heated to a temperature equal to or greater than the transformation temperature, it may revert from the second shape to the first shape. According to some aspects, the shape memory material may include one or more of a shape memory alloy (SMA), a shape memory polymers, a shape memory ceramic, an electroactive polymer, a conductive polymer, a dielectric elastomer, a thermoplastic elastomer, a phase change material, a bioinspired material, a carbon nanotube, a magnetostrictive material, an electrochromic material, a smart alloy, a smart composite, a magnetorheological fluid, a hydrogel, or the like. In embodiments utilizing an electrochromic material, the electrochromic material may be at least one of transition metal oxides (e.g. tungsten oxide, niobium oxide, etc), conducting polymers (e.g. polyaniline, polypyrrole), organic electrochromics (e.g. dye-based conducting polymers), metal complexes (e.g. Prussian blue), and the like. In some preferred embodiments, the shape memory material component includes an SMA. For example, the shape memory material may preferably include at least one or a copper-aluminum-nickel alloy or a nickel-titanium alloy.

According to embodiments in which the shape memory material is an SMA, the transformation temperature may be at least −10° C., at least 21° C., at least 30° C., or at least 40° C., and no more than 80° C., no more than 70° C., no more than 60° C., or no more than 50° C. Selecting a shape memory material with an appropriate transformation temperature for the particular device or application is important, as too high a transformation temperature may result in undesirably high power needs to induce a state change as well as a slower return to the second shape (e.g., making such materials disadvantageous for multiple lock and unlock devices). On the other hand, too low a transformation temperature may result in inadvertent or unintended unlocking if the can is exposed to higher than normal ambient temperatures.

The shape memory component included in the disclosed locking mechanisms may initially exist in the second shape which maintains the locking mechanism in the locked state. Then, upon application of sufficient energy, the shape memory component may revert to its first shape, converting the locking mechanism to an unlocked state and allowing access to the storage cavity and/or dosage form disposed therein. For example, the shape memory component may include an SMA, such as a copper-aluminum-nickel or nickel-titanium alloy, which is straight (“second shape”) when cold, but returns to its curved (“first”) shape, or vice versa when sufficient heat is applied. The energy applied may be in the form of heat, electricity, electromagnetism, mechanical strain, high frequency ultrasound, or a combination thereof. According to some embodiments, multiple shape memory components with relatively smaller dimensions (e.g., diameters or thicknesses) may be used rather than one larger shape memory component to decrease electricity required, speed up conversion time, and unlock the can quickly.

According to some aspects, a state change from the second shape to the first shape may be induced in the shape memory component by use of electrical current. For example, in some embodiments, current flowing through the shape memory component itself may generate sufficient heat to induce a state change from the second to the first shape. Such embodiments may be particularly advantageous when the shape memory component has a conductive shape memory material such as an SMA and/or a conductive polymer. In some embodiments, electrical current may be provided to a resistor positioned adjacent the shape memory component. In such embodiments, the resistor may increase in temperature due to the application of current and may transfer heat to the nearby shape memory component to raise the temperature of the shape memory component to or past its transformation temperature. In some embodiments, electrical current may be provided directly to the shape memory component, in combination with use of an additional resistor. In some embodiments, the shape memory component may be surrounded or placed in contact with a conductive material. In such embodiments, electrical current may be provided to the conductive material, which may then heat the shape memory component by contact and/or proximity.

According to some aspects, a state change from the second shape to the first shape may be induced in the shape memory component by use of electromagnetism. In some selected shape memory materials, such as ferromagnetic SMAs, a magnetic field may be applied to induce or facilitate a transition between shapes or induce additional strain, which may contribute to state conversion. In some cases, application of a magnetic field may change the energy barrier for a state change to encourage reversion to the first shape from the second shape.

According to some aspects, a state change from the second shape to the first shape may be induced in the shape memory component by use of sound waves. In some shape memory materials, high frequency ultrasound may be used to cause mechanical vibrations which can introduce mechanical strain on the shape memory material. Higher frequencies, in kilohertz to megahertz, can create intense sound waves that can cause localized thermal heating in the shape memory material to bring it above transformation temperature and cause a state change from the second to the first shape.

The locking mechanism and any one or more of its components may be secured, affixed to, or otherwise incorporated into a portion of the can including at least one of the lid, the base, the storage cavity, and other portions of the can. According to some aspects, this may be accomplished by at least a portion of the locking mechanism being overmolded by a portion of the can, snapping into a recess or receptacle of the can, being mounted to the can (e.g., by screws), being adhered to the can using an adhesive, or the like.

A variety of different locking mechanisms are disclosed herein, including but not limited to, a spring locking mechanism, a coil locking mechanism, an accordion locking mechanism, a removable locking mechanism, a magnetic locking mechanism, a hydrogel locking mechanism, a pressurized locking mechanism, or a piston locking mechanism.

Some embodiments may also include a locking state indicator that indicates to a user when the can is in a locked or unlocked state. This indication may take the form of a visual indication, a sound indication, or a tactile or vibrational indication. While in some embodiments, the locking state indicator is included in the can, in some additional or alternative embodiments, the locking state indicator may be included in the external device disclosed herein. In a preferred embodiment, the locking state indicator provides a visual indication, such as a change in color or pattern within and indicating window or aperture on the can itself, or the turning on or off of a light. Indications disclosed herein may be temporary, or permanent.

### Coil/Accordion Locking Mechanism

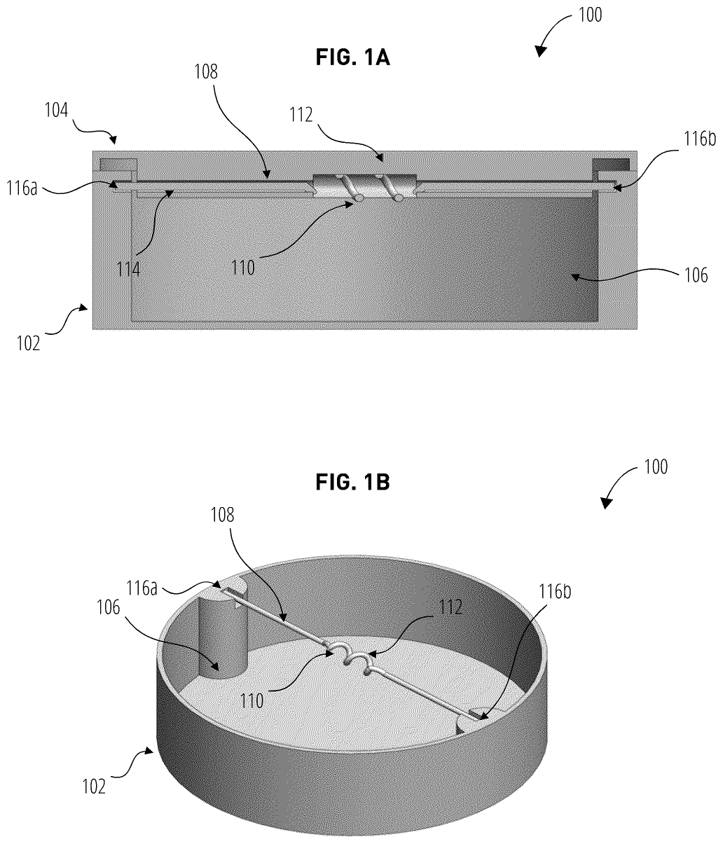

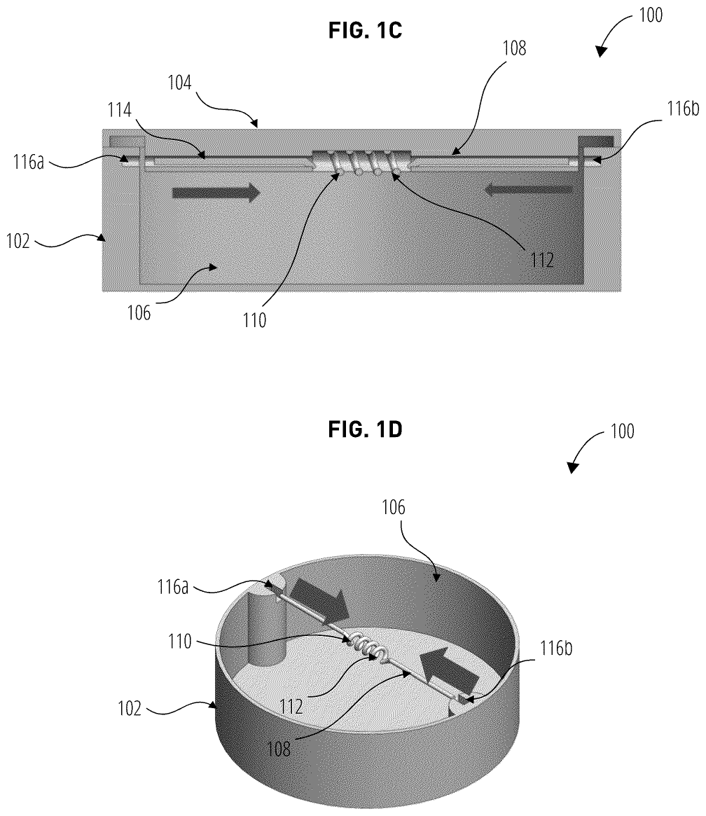

FIGS. 1A-D depict a coil locking mechanism according to an embodiment. As shown in FIG. 1A, can 100 may be formed of a base 102 and a lid 104, which together define a storage cavity 106, configured to store oral nicotine dosage forms. According to some embodiments, lid 104 may include locking mechanism 108. Locking mechanism 108 may be secured to the lid by overmolding, snap-in, mounting, or adhesive methods and structures. As shown in FIG. 1A, in some embodiments, locking mechanism 108 fits within channel 114 provided in lid 104, running along a diameter of the circular lid. In alternative embodiments in which the can 100 has a different shape (e.g., a cube, a pyramid, etc.), the locking mechanism 108 may run entirely across the length, width, or other applicable dimension of the lid 104.

As shown in FIG. 1A, the locking mechanism 108 may include a rod or wire formed into a coil 112. According to some embodiments, the rod or wire may have a diameter within the range of 0.1 mm to 3 mm, 0.5 mm to 2.5 mm, or 1.0 mm to 2.0 mm. While in the depicted embodiment the coil is provided in the center of the locking mechanism 108, in alternative embodiments, one or more coils could be provided at any point along the locking mechanism 108, or indeed, along the entire locking mechanism 108. Additionally or alternatively, an accordion or zig-zag structure could be provided in place of coil 112, with the same effect.

While a single wire and coil 112 is depicted in FIGS. 1A-D, in alternative embodiments, a plurality of wires and/or coils 112 may be provided, such as 2 or more, 3 or more, 4 or more wires and/or coils, and 6 or less, 5 or less, 4 or less, or 3 or less wires and/or coils. In embodiments where multiple wires and/or coils are provided, each wire may have a diameter smaller than the diameter which would be used in a single-wire embodiment. For example, each wire may have a diameter 10% to 20% smaller, 20% to 30% smaller, 30% to 40% smaller, 40% to 50% smaller or 50% to 60% smaller than the diameter used for a single-wire design, i.e., as disclosed above. Use of multiple smaller diameter wires may allow for faster heating and/or state change of the shape memory component from the second to first shape.

As shown in FIG. 1A, at least coil 112 is made of a shape memory material and therefore forms the shape memory component 110. According to some embodiments, additional portions, or all of locking mechanism 108, may be formed of the shape memory material. According to some embodiments, each coil 112 is formed of a shape memory material, while the remainder to the locking mechanism is not.

As shown in FIGS. 1A-B, the shape memory component 110 is disposed its second shape in which the coil 112 is expanded. This expanded position causes the length of the locking mechanism 108 to extend into a first locking cavity 116a at one end and a second locking cavity 116b at the opposing end, the locking cavities 116a,b being disposed in the sidewalls of the base 102. Locking cavities 116a,b are shown in cross-section in FIG. 1A and from a top-down view in FIG. 1B, in which the lid is not included. During manufacturing, locking mechanism 108 may be snapped into place in locking cavities 116a,b, when it is disposed in the second shape (i.e., when it is cool). Alternatively, locking mechanism 108 may be cooled to expand into place. In the latter case, the lids 104 would have to be kept at an appropriate (i.e., warmer) temperature before capping of the filled can, subsequently allowing ambient temperature to cool the shape memory component 110 for it to expand into the locking cavity 116.

As shown in FIG. 1A, when the shape memory component 110 is disposed in its second shape (i.e., with the coil 112 expanded), removal of lid 104 is not possible, since the ends of shape memory component 110 are trapped in first locking cavities 116a,b, as shown in FIG. 1A. However, when sufficient energy is applied to shape memory component 110 (i.e., using the radiofrequency component and shape memory component actuator component), it may revert to its first shape with the coil 112 in a contracted position, as shown in FIGS. 1C-D. This contracted position (i.e., the second shape) is shown in FIG. 1D, without the lid. As depicted here, with the shape memory component 110 reverted to its first shape, the locking mechanism 108 no longer extends into the first locking cavities 116a,b. As shown in FIG. 1C, this allows for removal of lid 104, i.e., converting the can into an unlocked state. For coil or accordion locking mechanism embodiments, like those depicted in FIGS. 1A-D, nitinol may be a particularly preferable shape memory material.

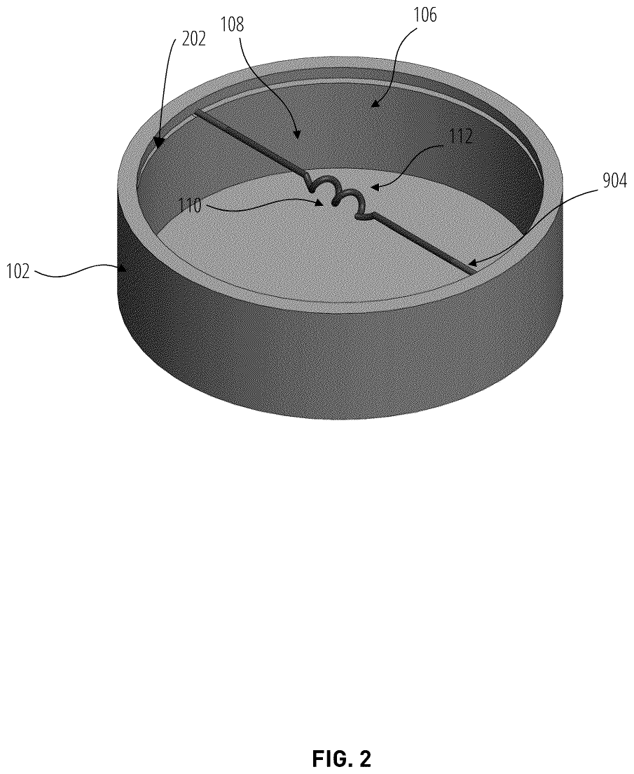

As shown in FIG. 2, in conjunction with the above-disclosed coil and accordion locking mechanism, some embodiments may include a base 102 having a locking slot 202 which may extend entirely or partially around the circumference of the base 102. As depicted in the exemplary embodiment of FIG. 2, the locking slot 202 extends entirely around the circumference of the cylindrical base 102. Such embodiments are advantageous in that they may increase ease of installation so that the locking mechanism may be mounted in varying locations and orientations, for example, in FIG. 2, in any orientation. In such embodiments, the lid can be placed on the base in any direction. This embodiment has the advantage that it does not need a specific orientation of the lid for the locking mechanism to engage with the locking slot 202.

In a cylindrical embodiment, as depicted in FIG. 2, the lid of the can may then be fixed in a single or limited (i.e., less than 360°, less than 180°, less then 90°, less than 45°, less than 10°, or less than 5°) rotational location via fixation with an adhesive (e.g., including epoxy and/or a sticker), a physical clip, or serrated components. For example, in an embodiment, the locking slot may be lined with serrations or teeth formed by alternating projections and valleys. In such an embodiment, once the locking mechanism extends into a valley of the serration, rotation out of that valley, i.e., over a projection, is inhibited, fixing the locking mechanism, and thereby the lid in place. At the same time, such embodiments do not require the lid to be placed on the can in any direction.

In some alternative embodiments, the circumferential side wall of the base may include a plurality of holes spaced around the circumference of the base. Each of these holes may be configured to engage with the locking mechanism of the lid, when the lid is dropped on to the base. In addition, protrusion or projections (e.g., extrusions) between adjacent holes could further force the locking mechanism to find a hole for its permanent position. In such embodiments, the process of capping the base after filling the storage cavity with dosage forms is made simpler since the locking mechanism can engage with any of the holes, similarly making the capping process orientation agnostic.

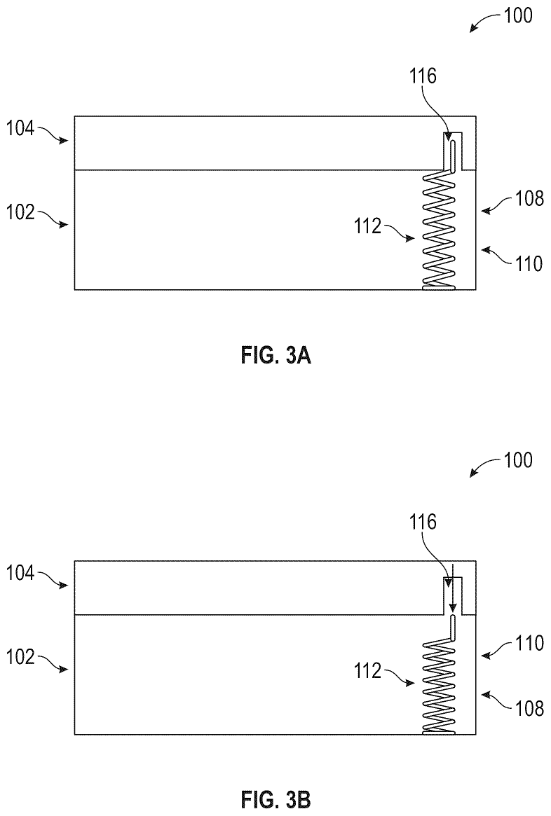

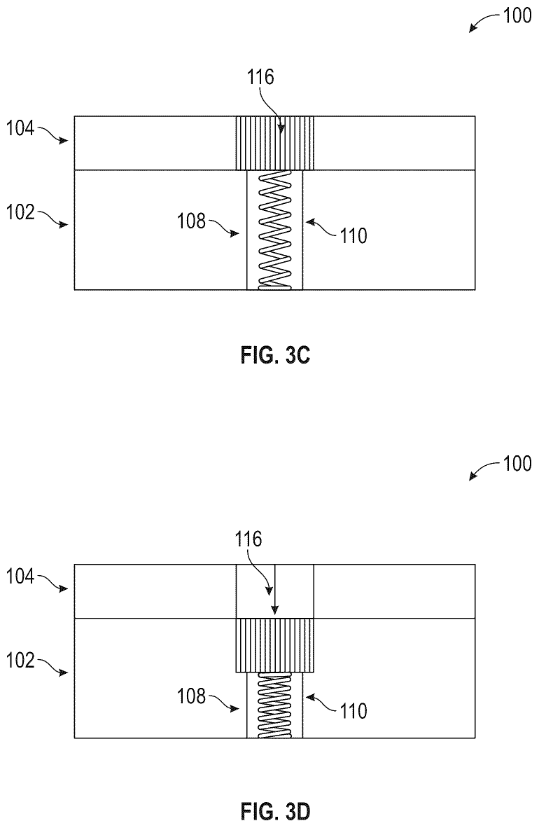

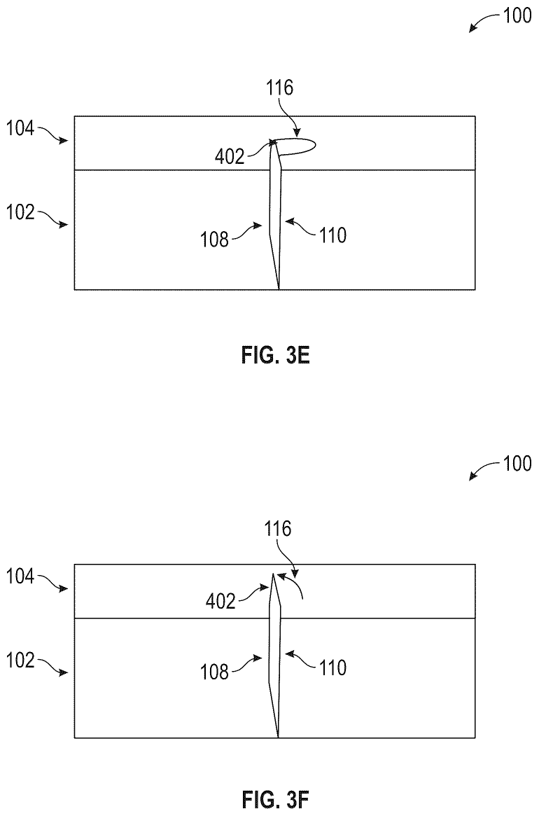

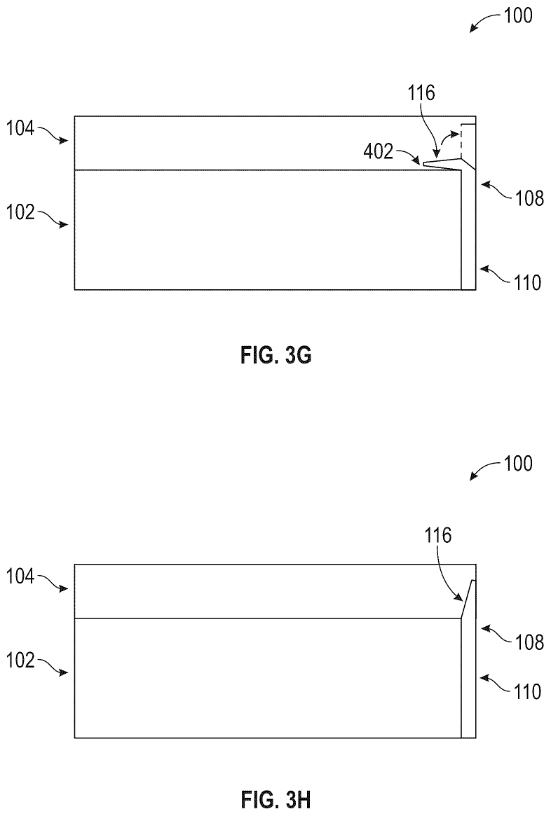

As shown in FIGS. 3A-H, while the disclosed coil or accordion type locking mechanisms may be disposed horizontally within the lid 104 (i.e., parallel to the upper surface of the lid and the bottom surface of the base), coil/accordion locking mechanisms 108 may alternatively be disposed vertically within the base 102. As in the horizontal embodiments disclosed above, vertical locking mechanisms 108 as disclosed in FIGS. 3A-B may include a shape memory component 110, including a coil 112, accordion, or zig-zag shape. The disclosed vertical embodiments may generally operate, be manufactured, and contain components as disclosed with respect to the horizontal embodiments, except in the vertical embodiments disclosed in FIGS. 3A-B, one or more locking cavity 116 may be provided in the lid 104.

As shown in FIG. 3A, the shape memory component 110 is disposed its second shape in which the coil 112 is expanded. This expanded position causes the length of the locking mechanism 108 to extend into locking cavity 116 disposed in the lid 104. When the shape memory component 110 is disposed in its second shape (i.e., with the coil 112 expanded), removal of lid 104 is not possible, since the end of shape memory component 110 is trapped in locking cavity 116, as shown in FIG. 3A. However, when sufficient energy is applied to shape memory component 110 (i.e., using the radiofrequency component and shape memory component actuator component), it may revert to its first shape with the coil 112 in a contracted position, as shown in FIG. 3B. As depicted here, with the shape memory component 110 reverted to its first shape, the locking mechanism 108 no longer extends into the locking cavity 116. This allows for removal of lid 104, i.e., converting the can into an unlocked state. While in some embodiments, such as those shown in FIGS. 3A-3B, the locking mechanism 108 may be disposed in or along a sidewall of the base 102, in alternative embodiments, the locking mechanism 108 may be disposed in the center of base 102, as shown in FIGS. 3C-D, or at other locations set inwards from the sidewall.

In vertical embodiment such as those disclosed in FIGS. 3A-D, the locking mechanism 108 may operate in conjunction with a rotational locking component which requires rotation of the lid 104 for its removal. In such embodiments, the vertical locking mechanism 108 is configured to prevent the necessary rotation of the lid 104 for removal, when it is disposed in its second shape. Such a rotational locking component may include a threaded locking component, such as a screw-off lid, squeeze-initiated take-off lid, and the like. Additionally, in such embodiments (as well as in horizontal locking embodiments) the locking mechanism 108 may include a plurality of locking mechanisms. In vertical embodiments including a rotational locking mechanism, a plurality of locking mechanisms, such as 2, 3, 4, 5, or 6 locking mechanisms, or ranges therein, may provide additional resistance to the rotation required for unlocking, thereby better preventing unauthorized access or breaking into the can.

According to some alternative embodiments, as shown in FIGS. 3E-H, the locking mechanism 108, in place of a coil or accordion, the locking mechanism 108 may include a shape memory component 110 including a tab 402. While in some embodiments only the tab 402 is made of a shape memory material, in other embodiments, additional portions of the locking mechanism 108, or indeed the entire locking mechanism 108 may be made of shape memory material. As depicted in FIG. 3E and FIG. 3G, the tab 402 have a bent configuration as their second shape. When disposed in their second shape, tab 402 engages with a locking cavity 116 within lid 104, thereby preventing removal of the lid and maintaining the can in its locked state. While in FIG. 3E and FIG. 3G this is shown as a right-angle bend, other configurations are possible, including bends at different angles, kinks, zigzags, curls, coils, and any other configuration sufficient to prevent passage of the tab through the locking cavity of the lid.

However, as depicted in FIG. 3F and FIG. 3H, when sufficient energy is applied to tab 402 to induce a state change in the shape memory material to convert it back to its first shape, tab 402 straightens. This allows for removal of the tab 402 from the locking cavity 116, allowing for lid 104 to be removed from base 102 and converting the can into an unlocked state.

While in some embodiments, such as those shown in FIGS. 3G-H, the locking mechanism 108 may be disposed in or along a sidewall of the base 102, in alternative embodiments, the locking mechanism 108 may be disposed in the center of base 102, as shown in FIGS. 3E-F, or at other locations set inwards from the sidewall.

### Removable Locking Mechanism

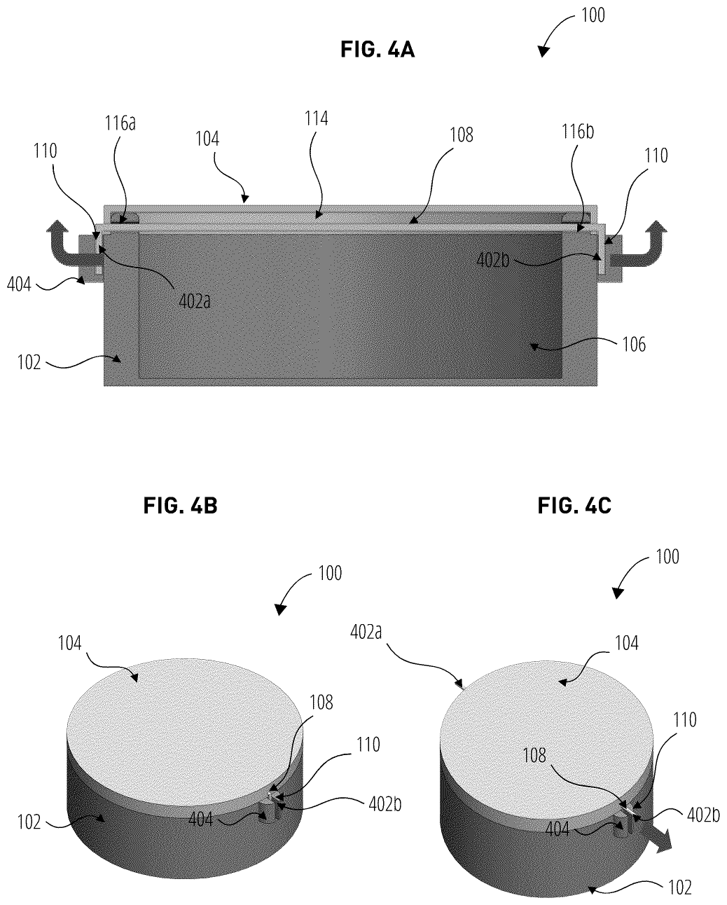

FIGS. 4A-C depict a removable locking mechanism according to an embodiment. As shown in FIG. 4A, can 100 may be formed of a base 102 and a lid 104, which together define a storage cavity 106, configured to store dosage forms such as oral nicotine dosage forms.

According to some embodiments, lid 104 may include locking mechanism 108. Locking mechanism 108 may be secured to the lid by overmolding, snap-in, mounting, or adhesive methods and structures. As shown in FIG. 4A, in some embodiments, locking mechanism 108 fits within channel 114 provided in lid 104, running along a diameter of the circular lid. In alternative embodiments in which the can 100 has a different shape (e.g., a cube, a pyramid, etc.), the locking mechanism 108 may run entirely across the length, width, or other applicable dimension of the lid 104. As shown in FIG. 4A, the locking mechanism 108 includes a rod or wire. According to some embodiments, the rod or wire may have a diameter within the range of 0.1 mm to 3 mm, 0.5 mm to 2.5 mm, or 1.0 mm to 2.0 mmm. As shown in FIG. 4A, the locking mechanism 108 fits within channel 114 of the lid and also extends through first locking cavities 116a,b of the base, coupling the lid to the base and preventing its removal. Accordingly, the passage of the locking mechanism 108 through both the channel 114 and the locking cavity 116 maintains the can in a locked state.

As shown in FIG. 4A, the locking mechanism 108 may include a shape memory component 110 including a tab 402, which may include a first tab 402a and a second tab 402b. In an embodiment, tabs 402a,b extend outwardly from the lid 104 and the base 102. According to some aspects, the tab 402 may be made of a shape memory material and therefore form the shape memory component 110. While in some embodiments only the tab 402 is made of a shape memory material, in other embodiments, additional portions of the locking mechanism 108, or indeed the entire locking mechanism 108 may be made of shape memory material. As depicted in FIG. 4A, the tab 402 has a bent configuration as its second shape. While in FIG. 4A this is shown as a right-angle bend, other configurations are possible, including bends at different angles, kinks, zig-zags, curls, coils, and any other configuration sufficient to prevent passage of the tab through channel 114 and locking cavity 116. Accordingly, while disposed in their second shape, tabs 402a,b cannot pass through channel 114 and locking cavity 116. This prevents removal of locking mechanism 108 and removal of lid 104 from base 102. Accordingly, the can is maintained in its locked state. FIG. 4B demonstrates a view of a locked can with tab 402 disposed in their second shape.

As shown in FIGS. 4A-C, the can may include a tab holder 404 configured to house the tab 402 when it is disposed in its second, i.e., locked shape. Accordingly, tab holder 404 may include a depression, recess, slot, or channel configured to accommodate tab 402 in the locked state, so as to prevent damage to the tab, the tab catching on objects, or poking of a user. The tab holder 404 may include a plurality of tab holders 404, such as a first and second tab holder, which generally match the number of tabs.

However, as depicted in FIG. 4C, when sufficient energy is applied to tab 402 to induce a state change in the shape memory material to convert it back to its first shape, tab 402 straighten. This allows for passage of the tab 402 through channel 114 and locking cavity 116 and removal of the locking mechanism 108. Once locking mechanism 108 is removed, lid 104 may be removed from base 102 and the can is in an unlocked state.

In various embodiments, the tab 402 or other portions of the locking mechanism 108 that are exposed to the outside can have a coating, such as a rubber or plastic coating, to prevent injury and mitigate risk of poking or scraping to users. While in some embodiments, the locking mechanism is entirely removed, in other embodiments, the locking mechanism, the shape memory component, and/or the tabs may remain as part of the can after unlocking. For instance, the tabs may furthermore be used as an aid, e.g., as a handle, in opening the can in addition to or instead of a can snap feature, which would allow the user to open the cans more easily. In such embodiments, the tabs may serve multiple functions including securing the can before it is unlocked, indicating to a user that a can is unlocked, and serving as a handle for users to more easily open the can.

While a single wire and set of tab 402 are depicted in FIGS. 4A-C, in alternative embodiments, a plurality of wires and/or sets of tabs 402 may be provided, such as 2 or more, 3 or more, 4 or more wires and/or sets of tab 402, and 6 or less, 5 or less, 4 or less, or 3 or less wires and/or coils. In embodiments where multiple wires and/or sets of tab 402 are provided, each wire may have a diameter smaller than the diameter which would be used in a single-wire embodiment. For example, each wire may have a diameter 10% to 20% smaller, 20% to 30% smaller, 30% to 40% smaller, 40% to 50% smaller or 50% to 60% smaller than the diameter used for a single-wire design, i.e., as disclosed above. Use of multiple smaller diameter wires may allow for faster heating and/or state change of the shape memory component from the second to first shape.

In conjunction with the above-disclosed removable locking mechanism, some embodiments may include a locking slot 202 which may extend entirely or partially around the circumference of the base 102, in place of locking cavities.

### Partial Opening Mechanism

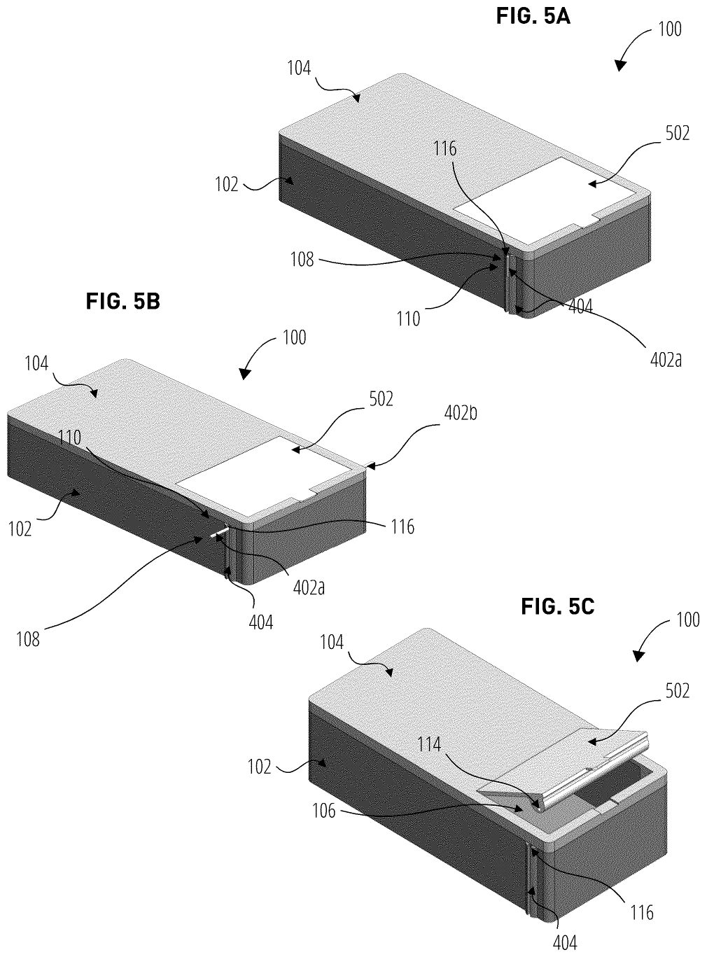

As shown in FIGS. 5A-C, while some embodiments may allow for complete removal of the lid, alternative or additional embodiments may utilize a partial opening mechanism, such as a lid or body having a partial opening mechanism, such as a hatch 502, which may open when the can is unlocked and be held shut when the can is locked. In such embodiments, the can 100 may similarly include a base 102 and lid 104. However, the lid 104 or a portion of the lid 104 may include hatch 502. As shown in FIG. 5C, the hatch 502 may include channel 114 through which locking mechanism 108 extends. According to the depicted example, locking mechanism 108 may also extend through locking cavity 116 of base 102 when the can is in a locked state, thereby securing the hatch shut and preventing its opening. In such embodiments, shape memory component 110 may include tab 402 which are disposed in a bent shape (i.e., their second shape), when the can is locked, as in FIG. 5A.

However, as depicted in FIG. 5B, when sufficient energy is applied to tab 402 to induce a state change in the shape memory material to convert it back to its first shape, tab 402 straighten. This allows for passage of the tab 402 through channel 114 and locking cavity 116 and removal of the locking mechanism 108. As shown in FIG. 5C, once locking mechanism 108 is removed, hatch 502 may be opened to allow access to dosage forms stored within the storage cavity, thereby converting the can to an unlocked state.

As shown in FIGS. 5A-C, the can may include a tab holder 404 configured to house the tab 402 when it is disposed in its second, i.e., locked shape. Accordingly, tab holder 404 may include a depression, recess, slot, or channel configured to accommodate tab 402 in the locked state, so as to prevent damage to the tab, the tab catching on objects, or poking of a user. The tab holder 404 may include a plurality of tab holders 404, such as a first and second tab holder, which generally match the number of tabs.

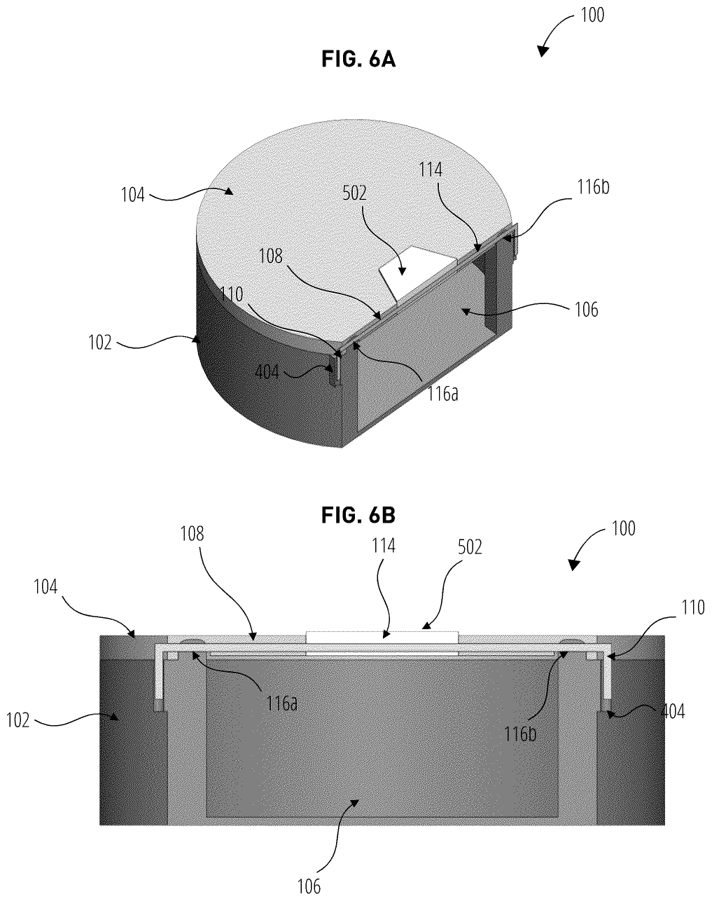

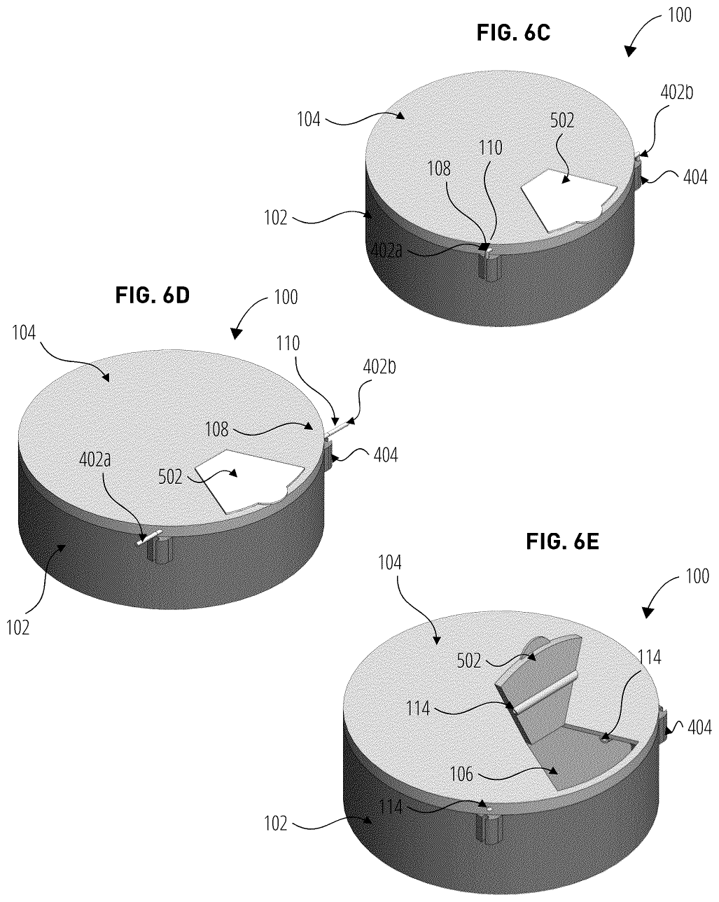

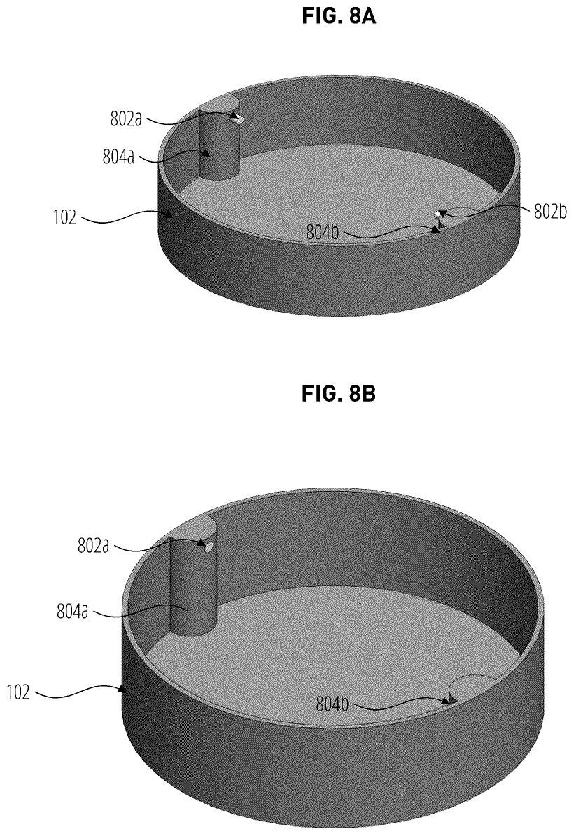

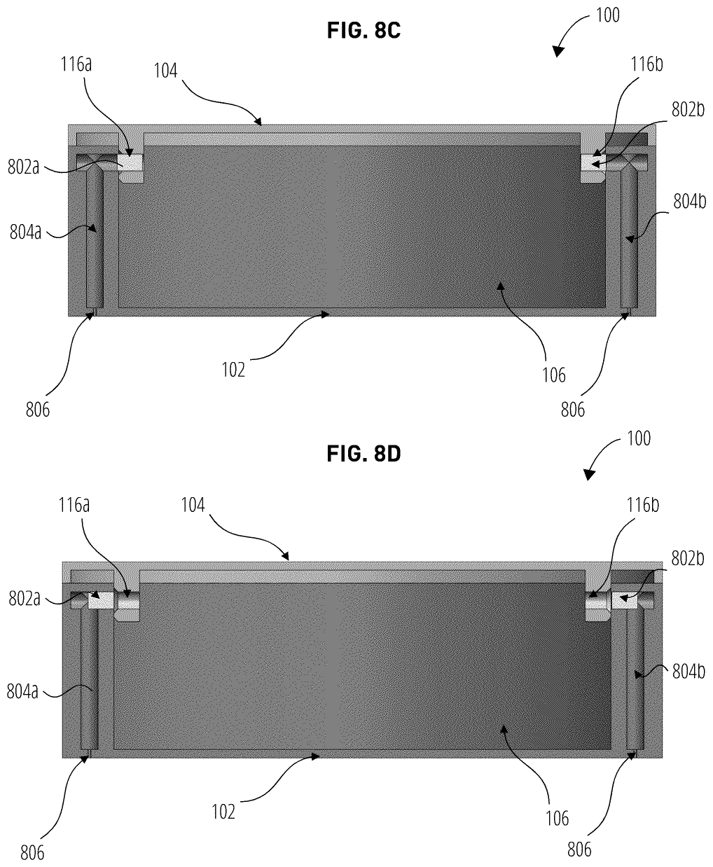

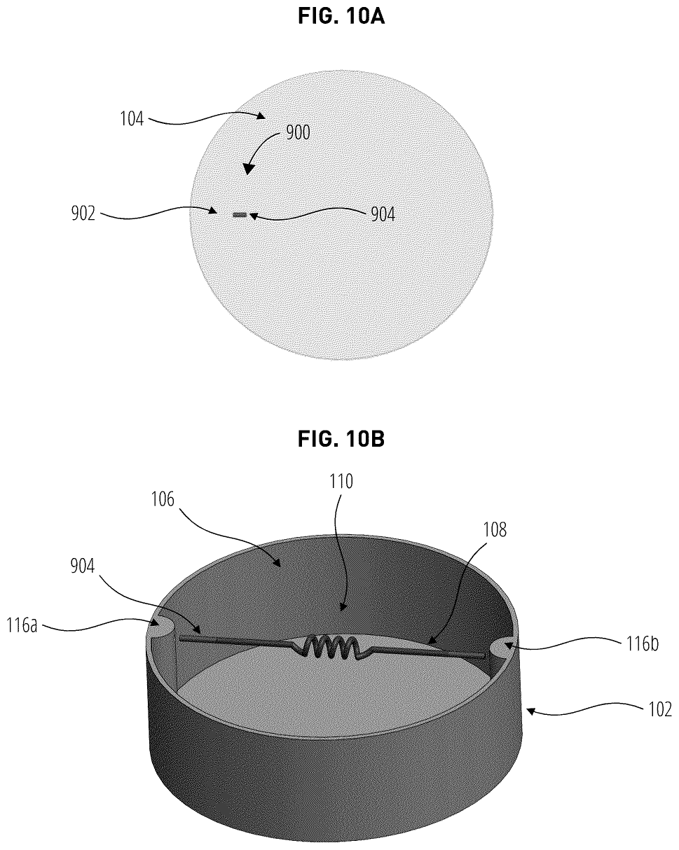

Hatch embodiments like those depicted in FIGS. 5A-C are not limited to cans having square, rectangular, or otherwise angled cross-sections. As shown in FIGS. 6A-D, hatch type access components may also be advantageously used in cylindrical cans. Such an embodiment is shown in cross-section in FIGS. 6A-B. As shown in FIG. 6A, cylindrical cans may utilize a hatch 502 which may open when the can is unlocked and be held shut when the can is locked. In such embodiments, the can 100 may similarly include a base 102 and lid 104. However, the lid 104 or a portion of the lid 104 may include hatch 502. In some cylindrical embodiments, the hatch may have a wedge shape as depicted in FIGS. 8A-D. However, the hatch shape is not particularly limited and may also be square, rectangular, oblong, or any other suitable shape. As shown in FIG. 10A, the hatch 502 may include channel 114 through which locking mechanism 108 extends. Channel 114 may also extend through the lid.

And, as more clearly shown in FIG. 6B, locking mechanism 108 may also extend through locking cavity 116 of base 102 when the can is in a locked state, thereby securing the hatch shut and preventing its opening. In such embodiments, shape memory component 110 may include tab 402 which are disposed in a bent shape (i.e., their second shape), when the can is locked. FIG. 6C shows an external view of a cylindrical can employing a hatch 502, where the can is in a locked state.

However, as depicted in FIG. 6D, when sufficient energy is applied to tab 402 to induce a state change in the shape memory material to convert it back to its first shape, tab 402 straighten. This allows for passage of the tab 402 through channel 114 and locking cavity 116 and removal of the locking mechanism 108. As shown in FIG. 6E, once locking mechanism 108 is removed, hatch 502 may be opened to allow access to dosage forms stored within the storage cavity, thereby converting the can to an unlocked state.

As shown in FIGS. 6A-E, the can may include a tab holder 404 configured to house the tab 402 when it is disposed in its second, i.e., locked shape. Accordingly, tab holder 404 may include a depression, recess, slot, or channel configured to accommodate tab 402 in the locked state, so as to prevent damage to the tab, the tab catching on objects, or poking of a user. The tab holder 404 may include a plurality of tab holders 404, such as a first and second tab holder, which generally match the number of tabs.

In conjunction with the above-disclosed partial opening mechanisms, some embodiments may include a locking slot 202 which may extend entirely or partially around the circumference of the base 102, in place of locking cavities.

### Magnetic Locking Mechanism

According to some embodiments, a magnetic component may be included in the locking mechanism in addition to or in place of the shape memory component. In such embodiments, the magnetic component may be positioned on or within the can such that the magnet holds the can shut (i.e., maintains the can in a locked state). Heating a magnet above its Curie temperature demagnetizes it, and letting it cool down effectively remagnetizes it. Accordingly, in order to convert the can to the unlocked state, the magnet may be heated above its Curie temperature using the same components and methods described herein to heat and/or deliver energy to the shape memory component, thereby demagnetizing the magnetic component and allowing for opening of the can. When the magnet cools, it will remagnetize, allowing for subsequent unlocking in some embodiments or alternatively, for use in a single, i.e., one-time, unlock embodiment.

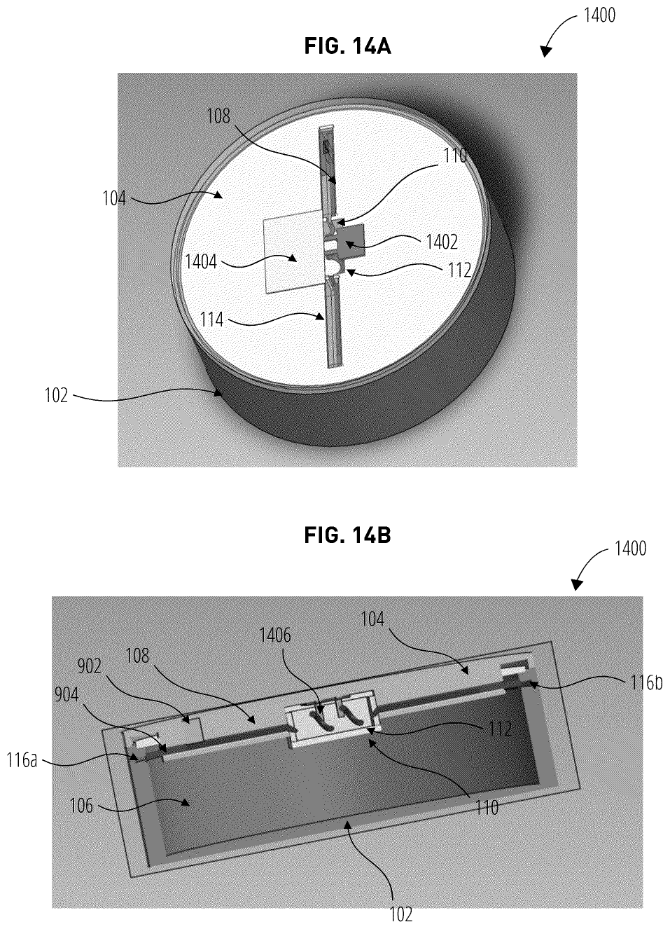

An exemplary embodiment of such a locking mechanism is illustrated in FIGS. 14A-B, and described in further detail below. Another embodiment may include an electromagnetic latch where the coil of wire, when energized, pulls a metal piece to secure the latch in place, and when de-energized, allows the latch to disengage, or vice-versa. In this embodiment, the current is flowing through the coil, generating a magnetic force that attracts the metal piece inside the can. When the current is turned off, the magnetic field vanishes, allowing the latch to be released and the can to be opened by a user. A further embodiment may include a system that employs magnetism and mechanical releases, whereby a can may include a plurality, e.g., 3, separate arms or latches that interact with the locking mechanism, whereby each arm can secure/release the lock. Such an embodiment could further include a piece of metal that adapted to interact both with the latches and with external magnets. According to an example, an external device such as an NFC or RFID reader would have 3 magnets (in this example) positioned where the latches align with the corresponding metal piece, and when aligned in the correct position, the magnets may attract/repel the metal, thereby holding or releasing the latches.

### Hydrogel Locking Mechanism

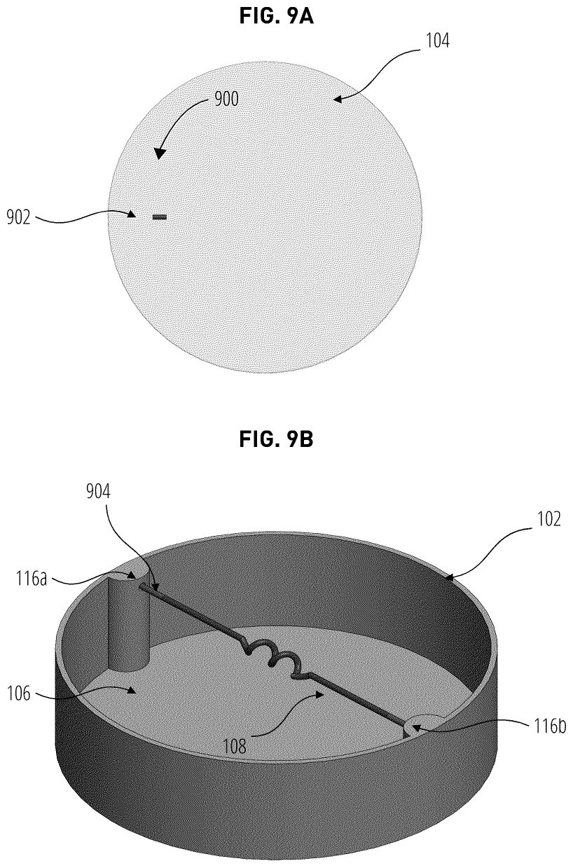

According to some embodiments, a hydrogel or magnetorheological fluid component may be included in the locking mechanism in addition to or in place of the shape memory component disclosed above. FIGS. 9A-D depict a hydrogel locking mechanism according to some embodiments. Hydrogels and magnetorheological fluids may be gel-like and liquid type fluids, respectively, and may respond to temperature and magnetic fields.

According to some embodiments, a can using a hydrogel locking mechanism may include a lid 104 and a base 102. The base 102 may include a locking slot 202 which may extend entirely or partially around the circumference of the base 102. As depicted in the exemplary embodiment of FIGS. 9C-D, the locking slot 202 extends entirely around the circumference of the cylindrical base 102. Such embodiments are advantageous in that they may increase ease of installation so that the locking mechanism may be mounted in varying locations and orientations, for example, in FIG. 2, in any orientation. In such embodiments, the lid can be placed on the base in any direction. This embodiment has the advantage that it does not need a specific orientation of the lid for the locking mechanism to engage with the locking slot 202.

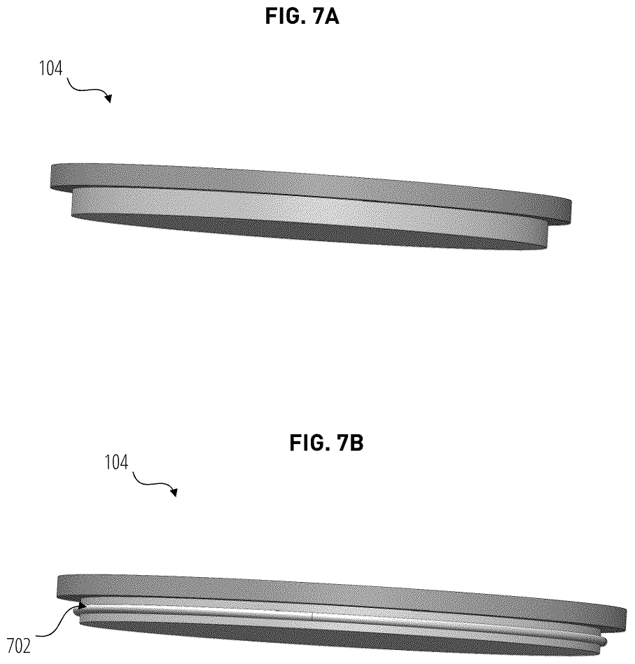

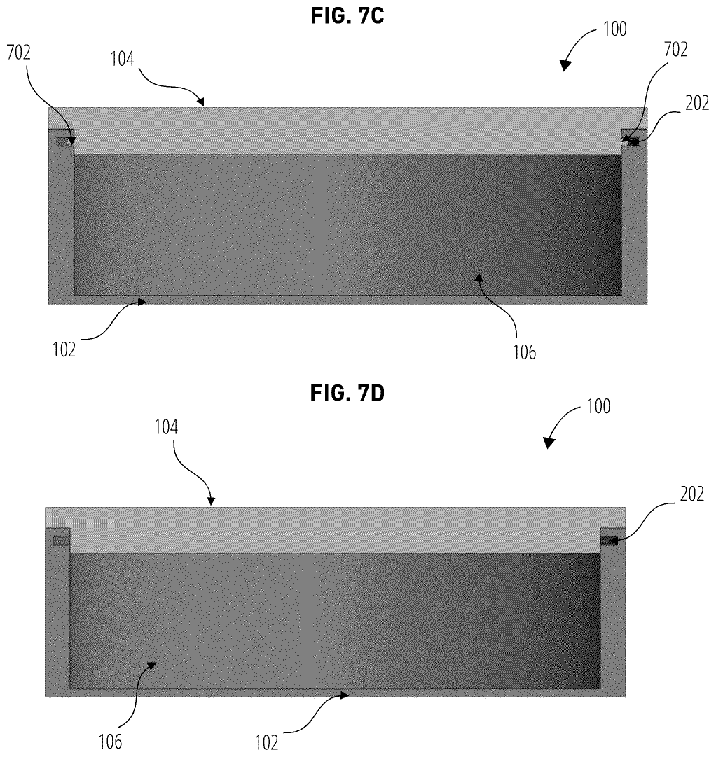

The lid may have a sack or compartment in it that provides space to fill a hydrogel or magnetorheological fluid in. In an alternative embodiment, the hydrogel or other fluid compartment is filled and then snapped closed with another inner lid, creating an area for the hydrogel to be stored. The sack may be adapted to expand and contract along with its contents, with features controlling the direction of expansion. For example, as shown in FIG. 7A, the lid may include a filled sack or compartment disposed along its circumference. As shown in FIG. 7A, the sack may initially be smooth when its contents are in an unexpanded state.

However, as shown in FIG. 7B, when voltage or magnetism is applied, the hydrogel or magnetorheological fluid may convert to an expanded state, e.g., to form a locking protrusion 702. As shown in FIG. 7C, locking protrusion 702 may engage with locking slot 202 to couple the lid to the can and prevent removal of the lid, thereby locking the can.

As shown in FIG. 7D, cooling or further application of energy to the can at a point of sale may convert the hydrogel or magnetorheological fluid to its initial, unexpanded state, causing it to disengage from the locking slot and allowing removal of the lid and unlocking of the can.

According to some embodiments, the sack may be made of a flexible material such as rubber, polyester, etc., and can provide the hydrogel means to expand in a controlled manner once the can is filled and the lid closes the can. For instance, at the end of the manufacturing step, voltage or magnetism can be applied to the closed can for the hydrogel to expand, until it is unlocked at the point of sale.

While FIGS. 7A-7D depict an embodiment with a locking slot 202 disposed in the base 102 and a locking protrusion 702 disposed in the lid, this configuration may be reversed so that the locking slot 202 is disposed in the lid 104 and the locking protrusion 702 formed by the sack and hydrogel is disposed in the base 102. In either embodiment, locking slot 202 may also be replaced by one or more locking cavities, in some embodiments.

### Pressurized Locking Mechanism

While some embodiments of the locking mechanism may utilize a shape memory component, as disclosed above, additional embodiments may employ a pressurized locking mechanism, such as a piston locking mechanism. FIGS. 8A-D depict a pressurized locking mechanism according to some embodiments. For example, as shown in FIG. 8A, the base 102 may include pistons 802. According to some embodiments, pistons 802 may include a first piston 802a and a second piston 802b. The base 102 may additionally include a pressure chamber corresponding to each piston. As shown in FIG. 8A, when the pressure chambers 804 are pressurized, the pistons 802 may protrude forward. Conversely, as shown in FIG. 8B, when the pressure chambers are depressurized, the pistons 802 may retract.

As shown in FIG. 8C, according to some embodiments, lid 104 may include first locking cavities 116a,b into which pistons 802 extend, when they are in the protruded state. Accordingly, the protruded pistons couple the lid to the base, preventing removal of the lid and locking the can.

Then, as shown in FIG. 8D, when the pressure chambers 804 are depressurized and the pistons 802 retract, they disengage from the locking cavity 116 of lid 104, allowing for removal of the lid and unlocking of the can.

According to some embodiments, the pressure chambers may be initially pressurized to lock the can, as a final or near final step during manufacturing. Then, upon interfacing with an external device, e.g., an NFC or RFID reader, the pressure chambers 804 may be depressurized, thereby unlocking the can. Depressurization of the pressure chambers may be accomplished by any suitable method. According to some embodiments, the external device may have a puncture tool or pins that interface with the pressure chamber 804 at a location 806 to puncture or otherwise open the pressure chambers to release pressurized air. Alternatively, the external device may be equipped to open valves disposed in the can to release pressurized air from the pressure chambers.

The pressurized locking mechanism disclosed herein may be used in place of or in addition to the shape memory and magnetic locking mechanisms disclosed herein. In some cases, other mechanical locking mechanisms may be employed in addition to the shape memory and/or magnetic locking mechanisms. For example, when a can is packaged, it may be provided with a secondary mechanical lock that can be only opened by a specialized machine that the retailer would have access to. An example includes crimping (bending) a metal band around the can and attaching the two ends with a pin. A machine accessible only at point-of-sale could knock out the pin which would then open the band. In such an embodiment, the machine may include a holding area that the can could be placed in. If needed, it could be clamped (via pressurized air, vacuum, motor, toggle clamp/by hand, etc.) to hold it more tightly while the pin was removed. The machine may additionally include a motor capable of activating a piston/screw that pressed directly on the pin and can generate enough force to remove it (e.g., an automatic arbor press).

### Locking State Indicator

As shown in FIG. 9A-B, some embodiments may comprise a locking state indicator. For example, the locking state indicator may include a window 902, a cut-out, a hole, an aperture, or a transparent portion in the lid or base, which shows part of the locking mechanism 108. Window 108 can function to visually indicate if a can is in a locked or unlocked state. For example, FIG. 9A shows a top-down view of a locking state window indicating that the can is in a locked state.

For instance, as shown in FIG. 9B, the majority of the locking mechanism, i.e., a first portion, may have a first pattern or color, while an indicator portion 904 of the locking mechanism may have a second, different pattern or color. As shown in FIGS. 2A-B, the first pattern or color of the locking mechanism may be exposed in a locked state.

Then, as shown in FIG. 10A, when the locking mechanism converts to its first shape and the can is converted to an unlocked state, the indicator portion 904 having the second pattern or color may be exposed in the window 902 indicating to the user or the store clerk that the unlocking of the can has been performed.

A view of the unlocked can, without the lid, is shown in FIG. 10B to further illustrate this conversion. While in some embodiments, as shown in FIGS. 2A-D, the indicator portion 904 is a part of the locking mechanism itself, in some embodiments, the indicator portion may be an additional or distinct component. For example, according to some embodiments, the shape memory component or another portion of the locking mechanism may be connected to a plastic piece that moves with the state change of the shape memory component, in order to provide a visual change, such as a color or pattern change in a window, indicating unlocked or locked.

In embodiments utilizing a locking state indicator 900, the locking mechanism and/or the indicator portion may advantageously include at least one of an electrochromic material, a hydrogel, a conductive polymer, or a shape memory polymer, as each of these materials may also undergo a color change (useful to visually indicate a locked vs unlocked state) in addition to a shape change, upon the application of sufficient heat and/or voltage. In the case of an electrochromic material, a transparent window that isolates the electrochromic material may be preferable. As a further example, a hydrogel may be displayed in a transparent window, which may change color in response to a temperature change created by applied voltage. Suitable examples would be PNIPAm, which can change from a swollen soft form to a firm form at 32° C. Lastly, conductive polymers or shape memory polymers can also allow for both a state/shape change using voltage, as well as a color change, using them for both unlocking as well as an indication that a can has been unlocked.

In some alternative embodiments, the locking state indicator may indicate a locked or an unlocked state by the turning on or off a light, by making a sound, by vibrating, or the like.

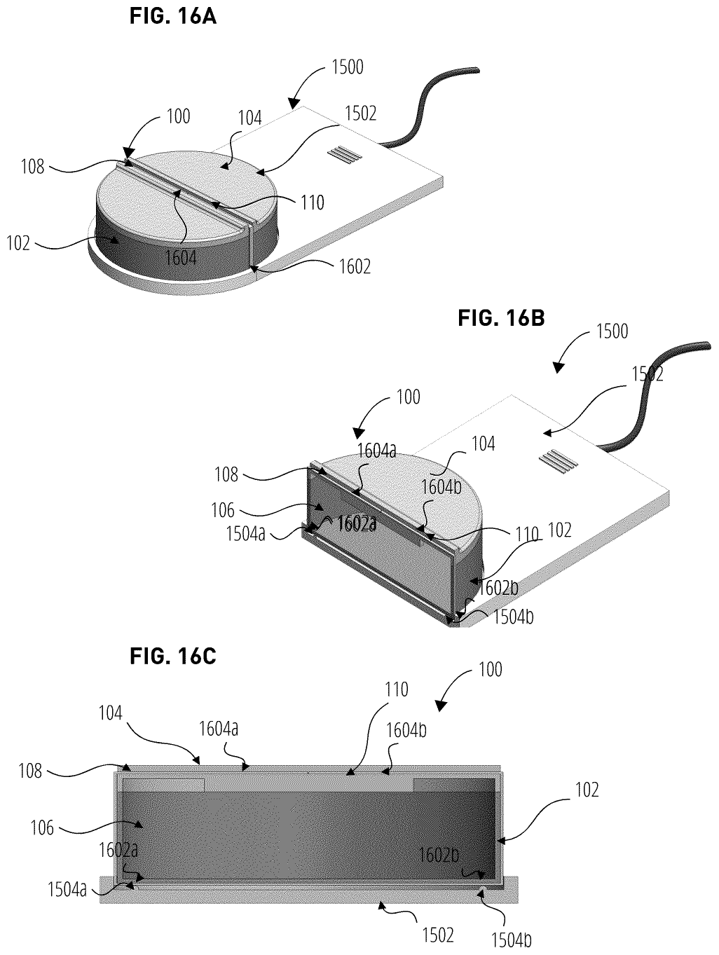

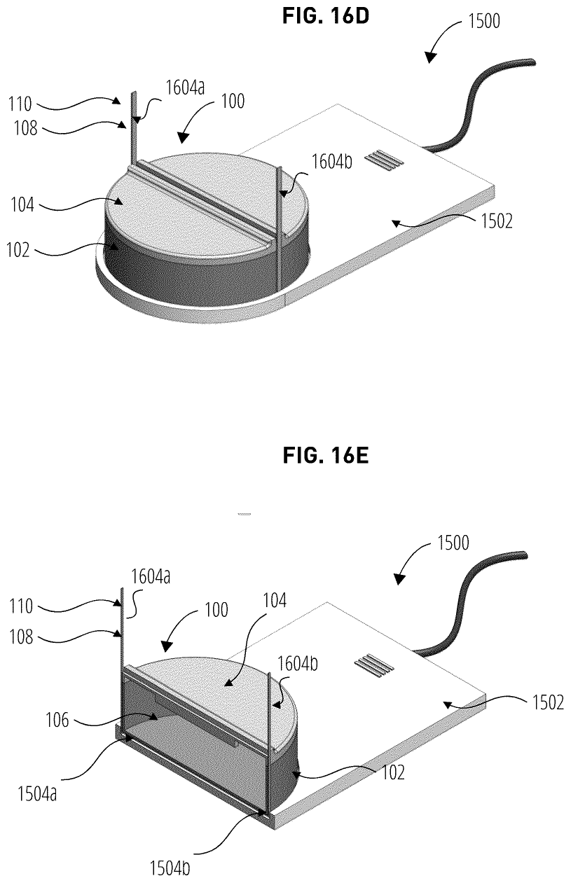

According to some embodiments, the shape memory component may act as a switch which completes or breaks a circuit as it converts from its second to its first shape. Accordingly, the state change of the shape memory component may turn “on” or “off” the aforementioned light, sound, vibration, or similar. Alternatively, such indicators may be powered by current provided by an external device, e.g., an external device including electrical nodes, as exemplified in FIGS. 16A-E.

### Radiofrequency Component

The disclosed cans may include a a radiofrequency component, which may include one or more of an NFC chip or an RFID chip. The NFC chip and/or RFID chip may be capable of executing a plurality of communication protocols that enables communication between two devices, such as, without limitation, the disclosed can and an external device. In the case of an NFC chip, such communication may be possible over a distance of 20 cm or less, 10 cm or less, 5 cm or less, or 4 cm or less. In the case of an RFID chip, such communication may be enabled over a range extending up to 10 meters, up to 25 meters, up to 50 meters, or up to 100 meters. The radiofrequency component may be enabled to receive a signal and initiate an action based on that signal. For example, the radiofrequency component may be enabled to receive an “unlock” signal from an external device and, with the help of a shape memory component actuator, create a state change in the shape memory component that converts the can from a locked to an unlocked state. According to some embodiments, the NFC or RFID chip the shape may comprise one or more of a printed circuit board (PCB), a capacitor, or a transducer.

The NFC chip and the RFID chip may each be included in an NFC tag or an RFID tag, respectively, the tag including an antenna along with the chip. The antenna may pick radio signals out of the air (e.g., radio signals generated by the external device) and convert them into voltage for recovery in a receiver. In an embodiment, the antenna may include a transducer. In some cases, a plurality of antennas may be connected to the NFC and/or RFID chip within the tag. In some embodiments, the radiofrequency component may include at least 2, at least 3, at least 4, or at least 5 antennae and no more than 10, no more than 8, no more than 6 or no more than 4 antennae. Inclusion of a plurality of antennas, such as within the disclosed ranges may be particularly advantageous in embodiments in which the can is entirely made out of or contains large percentages of metal. In such cases, the metal in the cans would normally interfere with radiofrequency signal. Accordingly, strategies of mitigating such interference, e.g., by improving reception by providing multiple antennae may be necessary. Alternatively, the antenna may be affixed on a shielding material or shielding tape, which mitigates metal interference. In a non-limiting example, an NFC chip that is connected to two antennas may communicate with an external device in both directions using a frequency of 13.56 MHZ in globally available unlicensed radio frequency ISM band using ISO/IEC 18000-3 air interface standard at data rates ranging from 106 to 424 kbit/s.

The radiofrequency component may be coupled with, secured to, affixed to, integrated within, or disposed within or on a portion of the can. For example, the radiofrequency component may be added as a sticker inside or outside of the base or lid of the can, underneath a sticker on the inside or outside of the can, inserted into a slot in the can or the lid, inserted into a slot that has two different materials on each side of the radiofrequency component, overmolded, and the like.

According to some aspects, the disclosed cans do not include a Bluetooth, Bluetooth low energy (BLE) module, or other Bluetooth components or capability. According to some aspects, storing or communicating information using Bluetooth technology may be too expensive and too advanced or use too much energy to be suitable for a use in low cost and potentially disposable consumer items such as cans for storage of oral nicotine dosage forms. On the other hand, method of encoding and transmitting information related using radiofrequency technology like NFC or RFID may be simple, cost effective, and ubiquitously used.

### Shape Memory Component Actuator

According to the present disclosure, a can comprising a locking mechanism and a radiofrequency component may receive a signal from an external device. The can may additionally include a shape memory component actuator which may be adapted to convert the received signal, e.g., an “unlock” signal, to a form of energy capable of creating a state change in the shape memory component thereby converting the locking mechanism from a locked to an unlocked state.

According to some aspects, the shape memory component actuator may receive electrical current from a transducer configured to transform radio waves received by the radiofrequency component into electrical energy. The transducer may be the antenna of the radiofrequency component or may be a separate component provided in addition to the antenna of the radiofrequency component. The shape memory component actuator may, upon receiving this electrical current, in some embodiments, provide electrical current directly to the shape memory component to create a state change from the second shape to the first shape, thereby unlocking the can. In such embodiments, the shape memory component actuator may contain one or more conductive components configured to transmit electrical current from the shape memory component actuator and/or the radiofrequency component to the shape memory component.

Alternatively or additionally, the shape memory component actuator may, upon receiving this electrical current, in some embodiments, provide heat energy to the shape memory component to create a state change from the second shape to the first shape, thereby unlocking the can. In such embodiments, the shape memory component actuator may contain one or more heating elements disposed around or disposed adjacent to the shape memory component. Such heating elements may include one or more resistive components and/or one or more conductive components. Accordingly, in such embodiments, the shape memory component actuator may be configured to transmit electrical current from the shape memory component actuator and/or the radiofrequency component to the heating element and thereby heat the shape memory component to create a state change from the second shape to the first shape, thereby unlocking the can.

According to one example, in an embodiment using an RFID reader/beacon, upon successful age verification or other authentication of a buyer, the RFID beacon may send an “unlock” signal to the RFID chip on a specific can, after that can is scanned at retail (for instance by using the bar code scanner during the checkout) or tapped onto a desktop reader (NFC chip, QR code, bar code, etc.). This “unlock” signal may in turn switch on the shape memory component actuator to supply electrical current to the shape memory component to induce a state change in order to unlock the can.

### Radiofrequency Component and Shape Memory Actuator Component Architecture

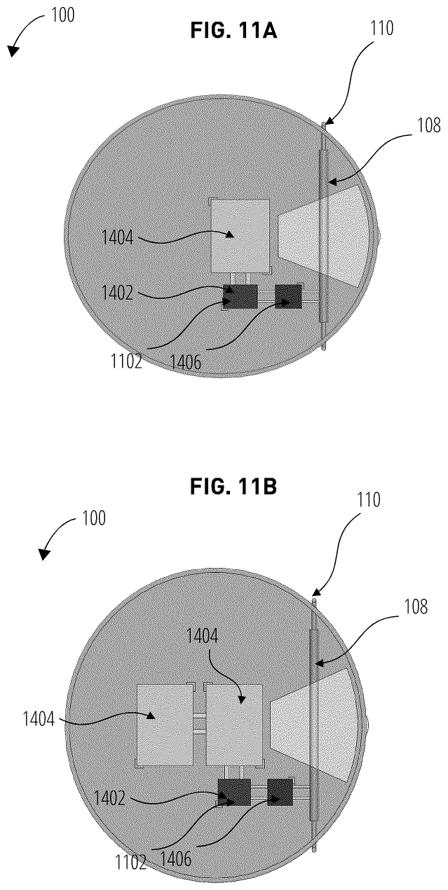

As exemplified in FIG. 11A, a can according to the present disclosure may contain a radiofrequency component 1102 and a shape memory component actuator 1406, in addition to the locking mechanism 108. According to some embodiments, the radiofrequency component 1102 may include at least one of an NFC chip 1402 or an RFID chip, along with an antenna 1404. The radiofrequency component 1102 may be electrically coupled with at least one of the shape memory shape memory component actuator 1406 and the locking mechanism.

In an embodiment, as shown in FIG. 11A, the antenna 1404 is electrically connected to an NFC chip 1402, which is electrically connected to the shape memory component actuator 1406, which is in turn electrically connected to the locking mechanism 108. Accordingly, when the antenna 1404 is brought near an external device, e.g., an NFC reader, it receives radio waves, which it converts to electrical energy and transmits to NFC chip 1402. The NFC chip 1402 may then transmit electrical current to the shape memory actuator 1406, which may provide electrical energy and/or heat to the locking mechanism 108 in order to convert the can from a locked to an unlocked state.

As shown in FIG. 11B, according to some embodiments, the can may be provided with a plurality of antennae 1404, for example, two antennae 1404. In embodiments in which the can is entirely made out of or contains large percentages of metal, such metal may interfere with radiofrequency signal typically used in, e.g., NFC and RFID devices. Accordingly, strategies for overcoming such challenges are needed in order to provide a reliable and functional radiofrequency enabled metal can. In some cases, metal interference may be mitigated by improving reception by providing multiple antennae and/or by affixing the antennae onto insulating tape.

While the exemplary embodiment shown in FIG. 11B shows two antennae oriented side-by-side, alternative embodiments may include an antenna connected to the circuit on either side of the can, allowing the can to be unlocked from both sides. For metal can embodiments, a small indent having, e.g., 1 mm depth, on the outside of a surface of the can may be sufficient to place the thin antenna, and then connect it to the PCB and SMA activation component. In certain embodiments, the antennae may be covered with a sticker or plastic piece to not be visible to end users.

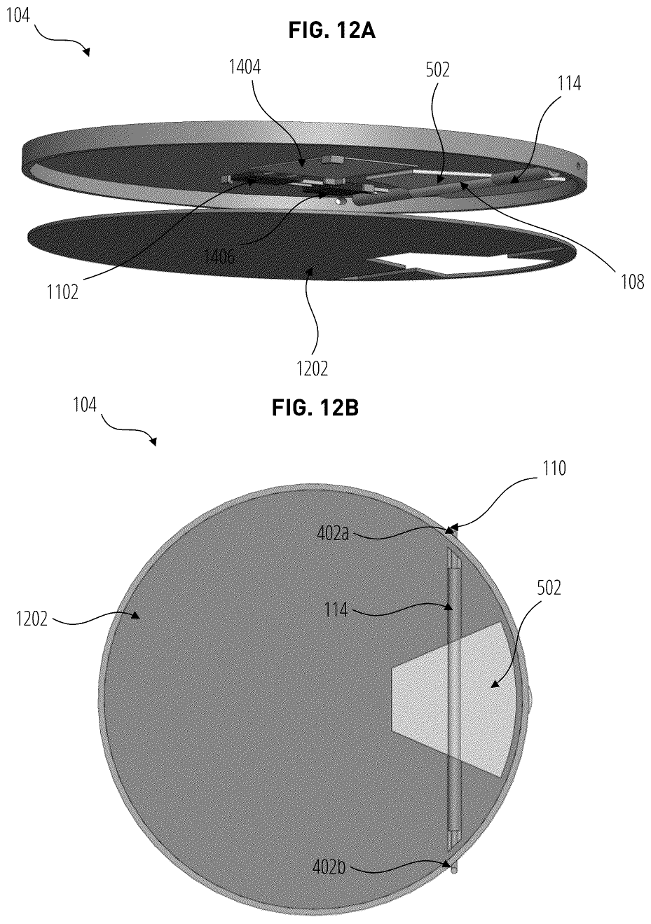

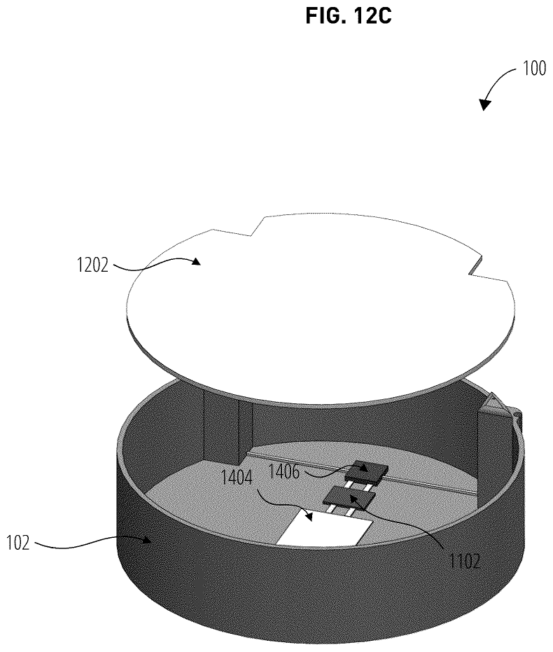

As shown in FIGS. 12A-B, the radiofrequency component 1102 and the shape memory component actuator 1406, may be included in the lid 104. According to some embodiments, the radiofrequency component 1102 and the shape memory component actuator 1406 may be secured to the lid 104 using a mounting feature including one or more of an inset, a raised feature, a slot, a pin, or any suitable known mounting features. Such mounting features may be formed by molding, casting, machining, or any other suitable known methods. According to certain embodiments, as shown in FIGS. 12A-B, these components may be protected and hidden by cover 1202. Cover 1202 may be secured to the main body of the lid by snapping, adhering, screwing in using standard or self-tapping screws, or by any other known and suitable securing means. FIG. 12A shows a view of a lid with cover 1202 detached. Conversely, FIG. 12B shows a view with cover 1202 attached to lid 104.

As shown in FIG. 12C, the radiofrequency component 1102 and the shape memory component actuator 1406, may be included in the base 102. According to some embodiments, the radiofrequency component 1102 and the shape memory component actuator 1406 may be secured to the base 102 using a mounting feature including one or more of an inset, a raised feature, a slot, a pin, or any suitable known mounting features. Such mounting features may be formed by molding, casting, machining, or any other suitable known methods. According to certain embodiments, as shown in FIG. 12C, these components may be protected and hidden by cover 1202. Cover 1202 may be secured to the main body of the base 102 by snapping, adhering, screwing in using standard or self-tapping screws, or by any other known and suitable securing means. FIG. 12C shows a view of a base 102 with cover 1202 detached.

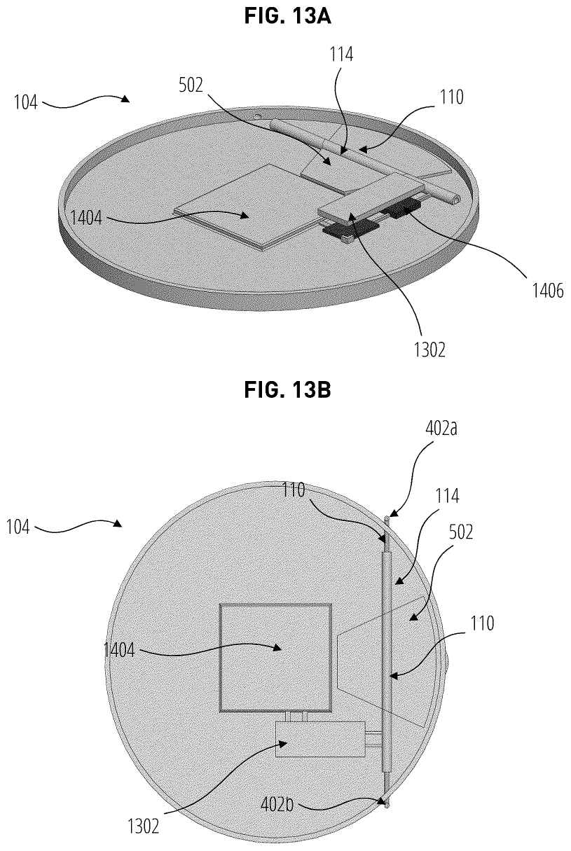

In other embodiments, the radiofrequency component 1102 and the shape memory component actuator 1406, may be protected and hidden by features other than a lid, such as overmolding, snap-on covers, or the like. While overmolding may be suitable for plastic components, e.g., lids and bases, it may not be suitable for attachment and covering of components to metal can components. FIG. 13A shows an exemplary lid with an overmolded antenna and a partially removed snap-on cover 1302 for securing the radiofrequency component 1102 and shape memory component actuator 1406. FIG. 13 B shows an embodiment in which snap-on cover 1302 is secured around radiofrequency component 1102.

FIG. 14A shows a top-down view of a lidded NFC enabled can 1400, according to an embodiment utilizing a coil or accordion-type locking mechanism. As shown in FIG. 14A, the base 102 is fitted with lid 104. Lid 104 contains a channel 114 into which locking mechanism 108 is fitted. Locking mechanism 108 contains a shape memory component 110 in the form of a coil 112.

In this embodiment, an NFC chip 1402, antenna 1404, and a shape memory component actuator 1406 are also disposed in or on the lid. Upon receiving a radio frequency signal, e.g., from an external device, a transducer may convert the energy into electrical energy which is stored in a capacitor of the NFC chip 1402. This energy can then be delivered to the shape memory component 110 via the shape memory component actuator 1406. The shape memory component actuator 1406 is connected to the shape memory component 110, delivering energy (in some embodiments, electrical energy) to change the shape memory component's 110 shape.

As shown in cross-section in FIG. 14B, base 102 is provided with first locking cavities 116a,b into which the locking mechanism 108 fits in a locked state, i.e., when coil 112 is in an expanded state, and from which the locking mechanism 108 will be released or withdrawn in an unlocked state, i.e., when coil 112 is in a contracted position. Lid 104 is also provided with a locking state indicator including a window 902 providing a view of the locking mechanism. Locking mechanism 108 includes an indicator portion 904 having a distinct color or pattern, which will move into view in window 902 when the coil 112 converts to its contracted state. FIG. 14B further depicts shape memory shape memory component actuator 1406 connected to shape memory materials in a small cavity within lid 104 that holds coil 112. In other embodiments, the NFC chip 1402 and shape memory shape memory component actuator 1406 can sit in other areas of the lid.

### Power Source

According to some embodiments, the can may include a power source, such as a battery, a piezo-electric starter, and the like. As used herein, a “power source” is an element configured to provide electric power to a circuit or device. According to some aspects, the power source may include, without limitation, a battery containing one or more cell chemistries such as, without limitation, lithium cobalt oxide (LCO), lithium nickel cobalt aluminum oxide (NCA), lithium nickel manganese cobalt oxide (NMC), lithium iron phosphate (LFP), and the like.

The power source may serve to provide electrical power to one or more of the locking mechanism, the shape memory component, the shape memory component actuator, the radiofrequency component, or any electrical component included within the can. In some instances, the power source may provide energy in addition to or in place of electrical current derived from radio waves received by the radiofrequency component and converted to electrical energy by the shape memory component actuator, in order to provide sufficient energy to induce a state change in the shape memory component.

According to some aspects, any battery included within the can may be eco-friendly, e.g., it may employ electrolytes comprising or consisting of biodegradable electrolytes, as well as replacing non-biodegradable, petroleum-based polymers with biodegradable or compostable polymers, thereby minimizing the usage of non-renewable resources in power source. In some instances, any battery within the disclosed can may also lack metal structural components, e.g., cases, shells, etc. By removing major metal structural components, using biodegradable polymers, and implementing biodegradable electrolytes, batteries may become biodegradable themselves. Such batteries may be particularly useful in conjunction with embodiments employing biodegradable or compostable materials in the can components such as the lid, the base, etc.

### External Device

As disclosed herein, the cans of the present application may include a radiofrequency component, e.g., they may be NFC and/or RFID enabled cans. As such, the disclosed cans may be capable of communication with an external device via the radiofrequency component.

According to some aspects, the external device may be one or more of an NFC reader, an RFID beacon, a cell phone, a smart phone, a computing device, a sound-based unlocking device, an electric-based unlocking device, a magnetic-based unlocking device, and the like.

According to some aspects, the external device may be a standard, i.e., “off-the-shelf” device such as a standard NFC or RFID reader. However according to alternative embodiments, the external device may include can interface elements specifically designed and adapted to interface with the disclosed cans, e.g., to assist with unlocking the cans. According to some aspects, the can interface elements may include one or more of an electrical node, a puncture tool, or similar.

In some embodiments, the external device may include an electrical node designed to make contact with a corresponding electrical contact of a can, when the can is tapped, or otherwise brought into contact with a surface of the external device. Such electrical nodes may include a plurality of electrical nodes, and may be configured to provide electrical power to components of the can, e.g., the locking mechanism, the shape memory component, the shape memory component actuator, or similar, when the external device is contacted by the can. For example, the external device may power the unlocking process via the electrical contacts. This may avoid the need for the unlocking process to be powered by intra-can components, such as the antenna/radiofrequency system and/or an internal power source such as a battery. This advantageously limits complexity, cost, weight, and material needs in cans, which may be produced as disposable items in high volumes.

### External Device—Electrical Nodes

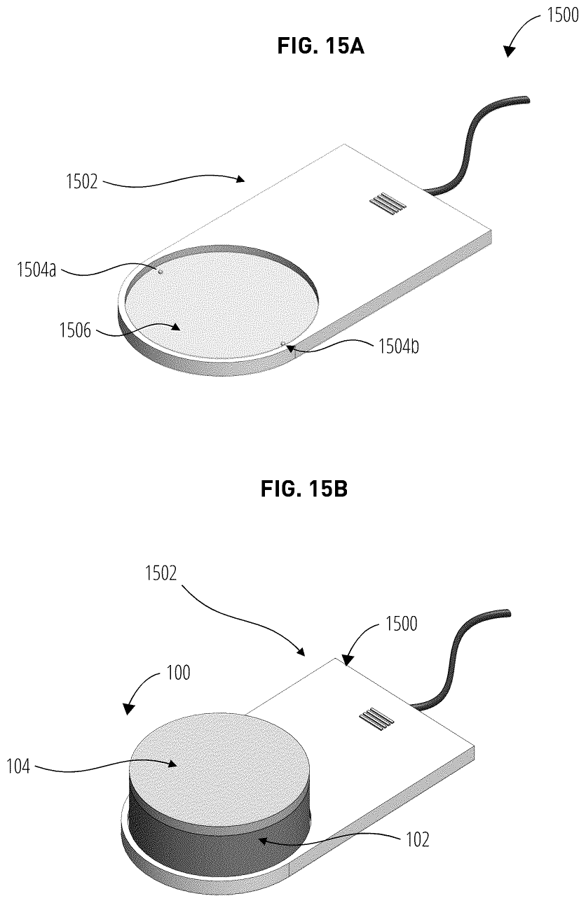

As shown in FIGS. 15A-B, the external device 1400 may be an NFC or RFID reader 1502, having electrical nodes 1504. According to an embodiment, the electrical nodes 1504 may include a first electrical node 1504a and a second electrical node 1504b. The electrical nodes 1504 may be positioned so as to make contact with corresponding electrical contacts of the can 100, when the can is brought into contact with the NFC or RFID reader 1502, as shown in FIG. 15B. In an exemplary embodiment show in FIG. 15A, electrical nodes 1504 are disposed on a flat contact area 1506, shaped and sized to accommodate a surface of can 100 which contains corresponding electrical contacts. According to the depicted embodiment, the contact area 1506 has a shape corresponding to a bottom surface of a cylindrical can.

Shaping the contact area 1506 containing the electrical nodes 1504 to correspond to the surface of the can 100 containing the corresponding electrical contacts may encourage a user to tap or otherwise place the appropriate surface of the can on the contact area 1506, as shown in FIG. 15B.

### External Device—Electrical Nodes & Shape Memory Component Locking Mechanism

As shown in FIGS. 16A-C, an external device 1400 having electrical nodes 1504 may be used to power the unlocking of a locking mechanism 108, such as a locking mechanism 108 having a shape memory component 110. As shown in FIG. 16A, a locked can 100 may be placed on an NFC or RFID reader 1502 equipped with electrical nodes 1504. As shown in FIG. 16A, the can may include electrical contacts 1602 configured to make contact with electrical nodes 1504, so as to form an electrical connection therebetween, when the can 100 is tapped, place on, or otherwise contacts contact area 1506 of the NFC or RFID reader 1502.

As shown in cross-section in FIGS. 15B-C, in an embodiment, electrical contacts 1602 may be a portion of, or may be continuous with the 6 ocking mechanism 108. Alternatively, electrical contacts 1602 may be distinct components from the locking mechanism, but may be electrically connected to the locking mechanism.

As shown in the exemplary embodiment of FIGS. 16A-C, the locking mechanism 108 includes a shape memory component 110. In the depicted embodiment, locking mechanism extends around the base 102 and lid 104, binding them together when the can is in a locked state. The locking mechanism includes two flanges extending from an outer edge of the lid, to meet in the center of the lid. At least the two flanges are made of shape memory material, although in some embodiments, additional portions of, or the entirety of, the locking mechanism 108 may be made of shape memory material. As shown in FIGS. 16A-C, the shape memory component 110 has a second shape in which the two flanges 1604 are closed, such that they meet in the center of the lid 104, binding the lid 104 and base 102 together to maintain the can in a locked state.

As shown in FIG. 16D, when the can is placed on contact area 1506 of the NFC or RFID reader 1502, electrical nodes 1504 are brought into contact with electrical contacts 1602. Thus, the NFC or RFID reader 1502 may deliver electrical current to the locking mechanism 108, causing shape memory component 110 to revert to its first shape, in which flanges 1604 are open, allowing for removal of the lid and converting the can to an unlocked state. While in some embodiments, electrical contacts 1602 may activate the shape memory component 110 by delivering electrical current thereto, in alternative embodiments, electrical contacts 1602 may deliver current to the shape memory component actuator 1406 and/or to a heating element, such as a resistive heating element, which heats the shape memory component 110, thereby activating it and causing it to revert to its first shape. FIG. 16E shows a cross-sectional view of the unlocked can described above.

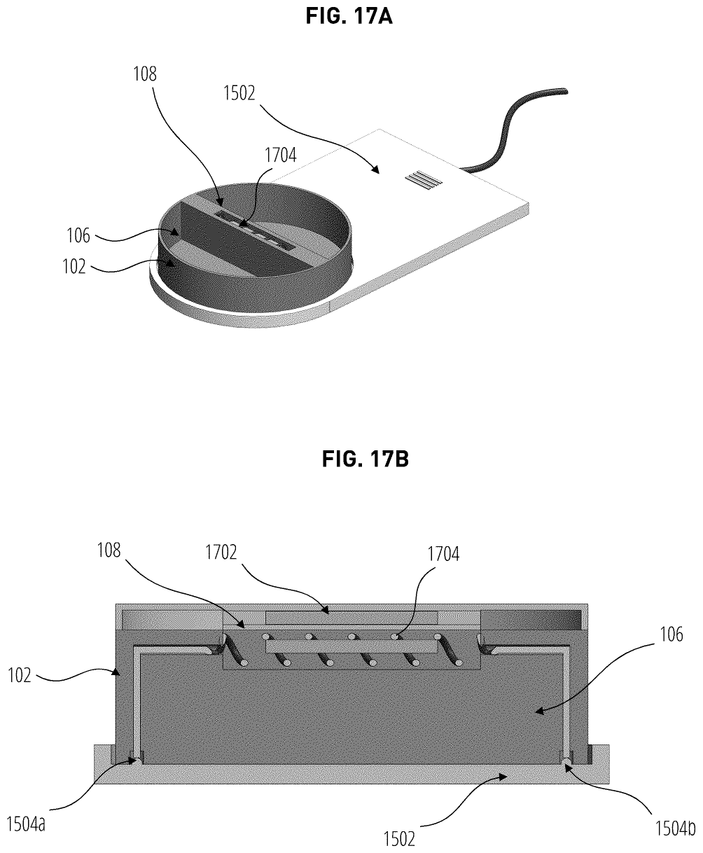

As shown in FIGS. 17A-B, an external device, such as an NFC or RFID reader 1502, having electrical nodes 1504 may be used to power the unlocking of a locking mechanism 108, such as a locking mechanism 108 having a magnetic component 1702. As shown in FIG. 17A, a locked can 100 may be placed on an NFC or RFID reader 1502 equipped with electrical nodes 1504. As shown in FIG. 16A, the can may include electrical contacts 1602 configured to make contact with electrical nodes 1504, so as to form an electrical connection therebetween, when the can 100 is tapped, place on, or otherwise contacts contact area 1506 of the NFC or RFID reader 1502.

As shown in the exemplary embodiment of FIGS. 17A-B, the locking mechanism 108 includes a magnetic component 1702. The magnetic component may include a positive magnetic component disposed in or attached to lid 104 and a negative magnetic component disposed in or attached to base 102 (or vice versa), binding them together when the can is in a locked state. According to the embodiment depicted in FIGS. 16A-B, the magnetic component provided in the base is surrounded by an electromagnetic coil 1704.

When the can is placed on contact area 1506 of the NFC or RFID reader 1502, electrical nodes 1504 are brought into contact with electrical contacts 1602. Thus, the NFC or RFID reader 1502 may deliver electrical current to the locking mechanism 108, causing current to flow through electromagnetic coil 1704, which demagnetizes the magnetic component 1702, allowing for removal of the lid and converting the can to an unlocked state. FIG. 16E shows a cross-sectional view of the unlocked can described above.

### External Device—Acoustic External Device

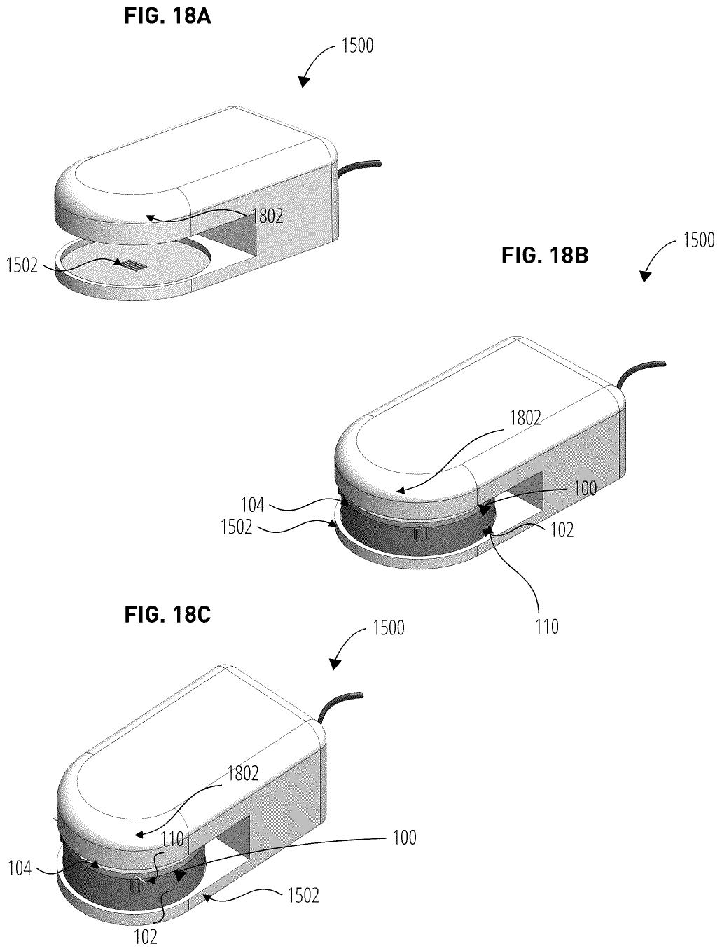

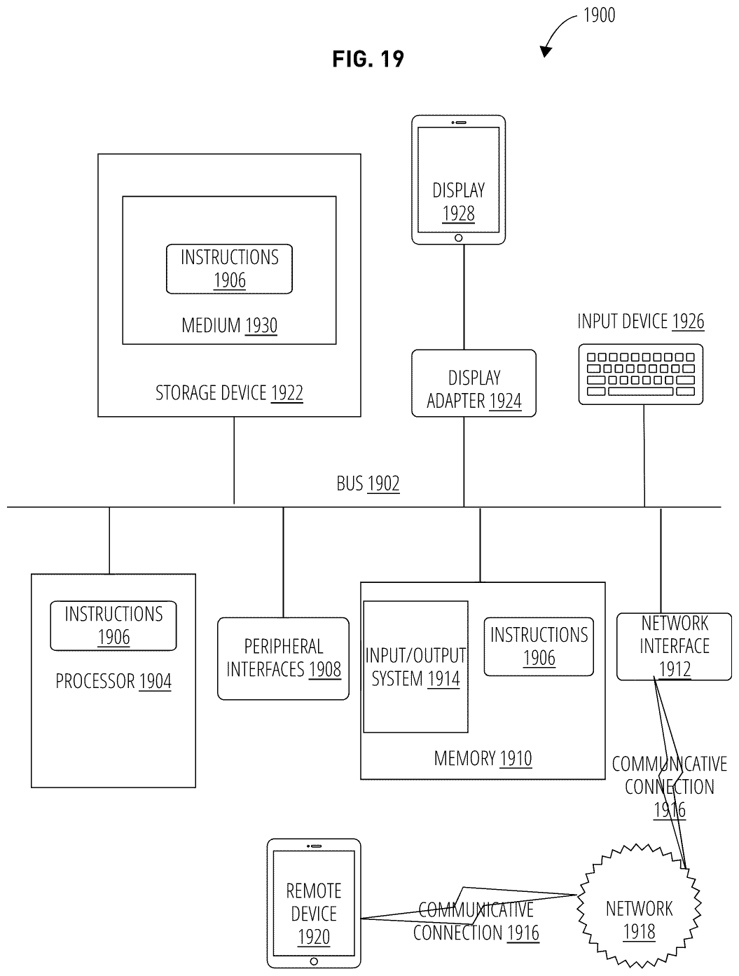

As shown in FIGS. 18A-C, an external device, such as an NFC or RFID reader 1502, may be equipped with a transducer 1802 configured unlock a locking mechanism 108, such as a locking mechanism 108 having a shape memory component 110. As shown in FIG. 18A, a locked can 100 may be placed on an NFC or RFID reader 1502 equipped with a transducer 1802.

When the can is placed on contact area 1506 of the NFC or RFID reader 1502, the transducer 1802 may produce acoustic waves that activate or facilitate activation of the shape memory component 110, causing it to convert to its first shape, allowing for removal of the lid and converting the can to an unlocked state, as shown in FIG. 18C.

### External Device—Computing Device

According to some embodiments, the external device may include a computing device.

A computing device includes a processor communicatively connected to a memory. The computing device may include any external device as described in this disclosure including an NFC reader, an RFID reader, an NFC chip, an RFID chip, a cellular phone, a smart phone, and the like. Further examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk. The computing device may further include or refer to a microcontroller, microprocessor, digital signal processor (DSP) and/or system on a chip (SoC). Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices.

Computing device may interface or communicate with one or more additional devices as described below in further detail via a network interface device.

A network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device.

Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

The computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magnetooptical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

FIG. 19 shows a diagrammatic representation of one embodiment of a computing device in the exemplary form of a computer system 1900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure.

Computer system 1900 includes a processor 1904 and a memory 1910 that communicate with each other, and with other components, via a bus 1902. Bus 1902 may include any of several types of bus structures including, but not limited to, a memory bus, a memory controller, a peripheral bus, a local bus, and any combinations thereof, using any of a variety of bus architectures.

Processor 1904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1904 may be organized according to Von Neumann and/or Harvard architecture as a non-limiting example. Processor 1904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC) Memory 308 may include various components (e.g., machine-readable media) including, but not limited to, a random-access memory component, a read only component, and any combinations thereof. In one example, a basic input/output system 1914 (BIOS), including basic routines that help to transfer information between elements within computer system 1900, such as during start-up, may be stored in memory 1910. Memory 1910 may also include (e.g., stored on one or more machine-readable media) instructions (e.g., software) 1906 embodying any one or more of the aspects and/or methodologies of the present disclosure. In another example, memory 1910 may further include any number of program modules including, but not limited to, an operating system, one or more application programs, other program modules, program data, and any combinations thereof.

Computer system 1900 may also include a storage device 1922. Examples of a storage device (e.g., storage device 1922) include, but are not limited to, a hard disk drive, a magnetic disk drive, an optical disc drive in combination with an optical medium, a solid-state memory device, and any combinations thereof. Storage device 1922 may be connected to bus 1902 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1922 (or one or more components thereof) may be removably interfaced with computer system 1900 (e.g., via an external port connector (not shown)). Particularly, storage device 1922 and an associated machine-readable medium 1930 may provide nonvolatile and/or volatile storage of machine readable instructions, data structures, program modules, and/or other data for computer system 1900. In one example, software 1906 may reside, completely or partially, within machine-readable medium 1930. In another example, software instructions 1906 may reside, completely or partially, within processor 1904.

Computer system 1900 may also include an input device 1926. In one example, a user of computer system 1900 may enter commands and/or other information into computer system 1900 via input device 1926. Examples of an input device 1926 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1926 may be interfaced to bus 1902 via any of a variety of interfaces (not shown) including, but not limited to, a serial interface, a parallel interface, a game port, a USB interface, a FIREWIRE interface, a direct interface to bus 1902, and any combinations thereof. Input device 1926 may include a touch screen interface that may be a part of or separate from display 1928, discussed further below. Input device 1926 may be utilized as a user selection device for selecting one or more graphical representations in a graphical interface as described above.

A user may also input commands and/or other information to computer system 1900 via storage device 324 (e.g., a removable disk drive, a flash drive, etc.) and/or network interface input device 1926. A network interface device, such as network interface device 340, may be utilized for connecting computer system 1900 to one or more of a variety of networks, such as network 344, and one or more remote devices 1920 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1918, may employ a wired and/or a wireless mode of communication. In general, any network topology may be used. Information (e.g., data, software 1906, etc.) may be communicated to and/or from computer system 1900 via network interface 1912.

Computer system 1900 may further include a video display adapter 1924 for communicating a displayable image to a display device, such as display 1928. Examples of a display 1928 include, but are not limited to, a liquid crystal display (LCD), a cathode ray tube (CRT), a plasma display, a light emitting diode (LED) display, and any combinations thereof. Display adapter 1924 and display 1928 may be utilized in combination with processor 1904 to provide graphical representations of aspects of the present disclosure. In addition to a display device, computer system 1900 may include one or more other peripheral output devices including, but not limited to, an audio speaker, a printer, and any combinations thereof. Such peripheral output devices may be connected to bus 1902 via a peripheral interface 1808. Examples of a peripheral interface 1808 include, but are not limited to, a serial port, a USB connection, a FIREWIRE connection, a parallel connection, and any combinations thereof.

### External Device—NFC or RFID Reader

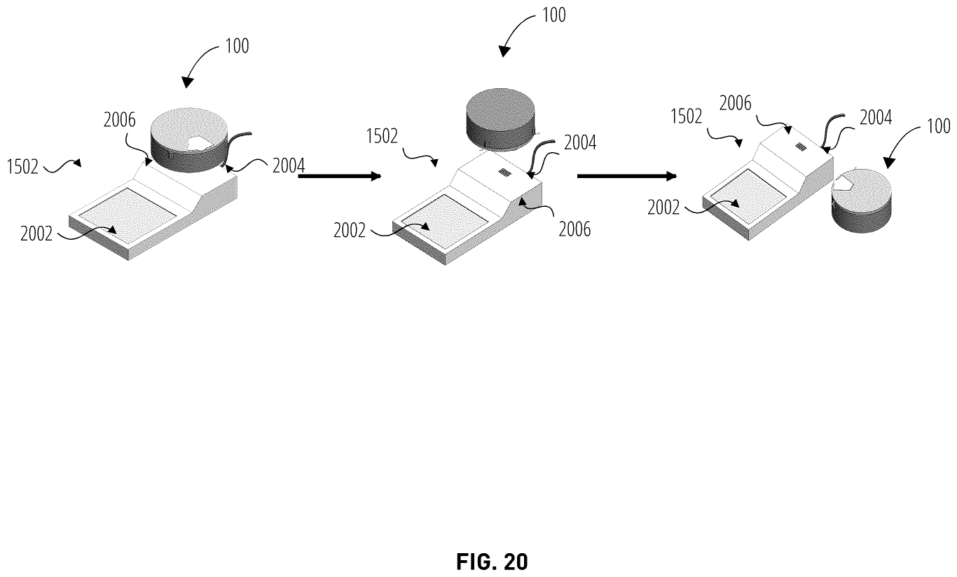

According to some embodiments, the external device may include an NFC or RFID reader. The NFC or RFID may support a plurality of radio-frequency (RF) protocols such as one or more of Zigbee, Bluetooth Low Energy, Wi-Fi, and the like. In some embodiments, the NFC or RFID reader may initiate communication with the radiofrequency component; for instance, and without limitation, the NFC or RFID reader may send one or more commands to the radiofrequency component, such as to unlock a can. For example, as illustrated in FIG. 20, at point-of-sale, NFC or RFID reader 1502 provided to authorized retailers can 100 unlock a can by placing the can near the reader when age verification is performed. This allows for age verification at the point of sale to be enforced.

In some embodiments, the NFC or RFID reader may be capable of writing data onto the radiofrequency component. In a non-limiting example, the NFC or RFID reader 1502 may be used to write a generated unique ID onto the radiofrequency component. Subsequently, the NFC or RFID reader may save the ID of the can and send the ID to a server. This may allow for traceability of product in the supply chain and counterfeit prevention. Further, it may allow devices that were sold to minors to be traced back to the retail location and the time of purchase. If this is a consistent pattern of underage usage, this data can be used by the retailer, the company, or the Food and Drug Administration (FDA) to determine if a systemic underage sale problem exists and what action steps are best taken.

According to some aspects, as exemplified in FIG. 20, the NFC or RFID reader 1502 may include an outer body 2006, a display 2002, a power source 2004, a processing circuit, and, in some embodiments, a camera for date of birth recognition, ID reading, or other collection of user metadata. The display 2002 may include any display as described in the entirety of this disclosure such as a light emitting diode (LED) screen, liquid crystal display (LCD), organic LED, cathode ray tube (CRT), touch screen, or any combination thereof. In a non-limiting embodiment, the display may include a graphical user interface (GUI) configured to display any information from, e.g., a can, or any computing device.

According to some aspects, the power source may be connected to a plurality of electronic device or components such as, without limitation, display, control circuit, and the like thereof. The power source may include, without limitation, a battery containing one or more cell chemistries such as, without limitation, lithium cobalt oxide (LCO), lithium nickel cobalt aluminum oxide (NCA), lithium nickel manganese cobalt oxide (NMC), lithium iron phosphate (LFP), and the like. In some embodiments, the power source may be rechargeable, such as by using a charging connector. For instance, and without limitation, charging connector may include an inductive charging coil whereby electrical power is transferred to the inductive charging coil using a varying exterior magnetic field supplied by another device or a conductive connection from NFC or RFID reader to an outlet or other external power source.

As used herein, a “processing circuit” is a circuit configured to perform processing and/or memory functions. In a non-limiting example, the processing circuit may be configured to process any method, method step, or sequence of method steps in any embodiment described in this disclosure, in any order and with any degree of repetition. The processing circuit may include any computing device as described in this disclosure, including without limitation a microcontroller, microprocessor, digital signal processor (DSP) and/or system on a chip (SoC) as described in this disclosure. The processing circuit may include a single computing device operating independently, or may include two or more computing device operating in concert, in parallel, sequentially or the like; two or more computing devices may be included together in a single computing device or in two or more computing devices.

According to some embodiments, the processing circuit may be configured to receive identification data associated with a can. As used in this disclosure, “identification data” is data that uniquely identifies the can, a user or purchaser of the can, and/or a retailer of the can. In some embodiments, identification data may include, without limitation, production timestamp, production line serial number, device serial number, device ID, batch number, and the like thereof. Additionally or alternatively, identification data may include user/purchaser metadata. As used in this disclosure, “user metadata” is data that provides information about user of a can or the dosage forms stored therein. In some cases, user may include a buyer of the can who purchases the can from a retailer. In other cases, user metadata may include a retailer who stocks the can from a supplier (such as a vendor). In some embodiments, user metadata may be received, collected, or otherwise gathered, by the processing circuit, from the user at the time of purchasing. User metadata may include one or more of a purchase timestamp, name, address, email address, date of birth, user identification, driver license number, passport number, government ID number, age, and the like thereof. In a non-limiting example, user metadata may be generated, by the processing circuit, as a function of a transaction. For instance, and without limitation, user metadata may be collected from payment and/or ID verification during the transaction.

Additionally, or alternatively, the processing circuit may be configured to receive usage data associated with external device. As used in this disclosure, “usage data” refers to information related to how external device is used by the associated user. In an embodiment, usage data may be used to provide insights into user behavior. In a non-limiting example, usage data may include frequency of purchases of cans, number of cans per purchase, strength (i.e., dose of nicotine per dosage form) and/or flavor of dosage forms purchased, brand of dosage forms purchased, and the like.

According to some aspects, the NFC or RFID reader may be integrated with a point-of-sale system at a retail location for cans and/or oral nicotine dosage forms. In an embodiment, point of sale system may be configured to receive user metadata and transmit the user metadata to the NFC or RFID reader. User metadata may be derived from a government issued ID, driver's license, passport, and the like. For example, the point-of-sale system may include a barcode scanner, touch screen, biometric sensors, and the like. Additionally, or alternatively, the NFC or RFID reader may be configured to unlock and/or lock a product based on the received user data from the point-of-sale system, described in more detail below. Further, the NFC or RFID reader may be configured to receive sales activity data at a sales location associated with cans and/or oral nicotine dosage forms, aggregate the sales activity data, and determine activity patterns associated the point of sale system based on the aggregated data.

The NFC or RFID readers and/or computing devices described herein may incorporate any one or more aspects of the external devices disclosed herein, such as, without limitation, electrical nodes, puncture tools, acoustic capabilities or transducers, magnetic components, and the like.

### Dosage Forms

In some aspects, the disclosed devices systems, and methods may secure packaging, e.g., cans, containing dosage forms such as oral nicotine dosage forms. According to some embodiments, the dosage forms within the disclosed cans consist of oral nicotine dosage forms and the disclosed cans do not include dosage forms other than oral nicotine dosage forms. The disclosed oral nicotine dosage forms include one or more of pouches, films, lozenges, gum, oral pouch-less products (non-dissolvable), or similar. According to some aspects, the disclosed oral nicotine dosage forms do not include ingested dosage forms such as pills, capsules, tablets, or the like. In some embodiments, the oral nicotine dosage forms may comprise tobacco, while in alternative embodiments the oral nicotine dosage forms consist of tobacco-free oral nicotine dosage forms and the oral nicotine dosage forms and cans do not contain tobacco. According to some aspects, the disclosed dosage forms include an active ingredient comprising or consisting of nicotine. While in some embodiments, the disclosed cans may include dosage forms having an active ingredient including one or more of prescription pharmaceuticals, over-the-counter (OTC) pharmaceuticals, pain killers, nutraceuticals, vitamins, homeopathics, or antioxidants, in alternative embodiments, the disclosed cans do not contain dosage forms including an active ingredient including one or more of prescription pharmaceuticals, over-the-counter (OTC) pharmaceuticals, pain killers, nutraceuticals, vitamins, homeopathics, or antioxidants.

According to some embodiments, the disclosed devices, systems, and methods may secure packaging, e.g., cans, containing dosage forms including cannabinoids in addition to, or in place of nicotine. As used herein, cannabinoids include one or more of tetrahydrocannabinol (THC), cannabidiol (CBD), cannabigerol (CGB), cannabinol (CBN), terpenes, or any other natural or synthetic active ingredient found in or derived from the Cannabis plant.

### Methods of Age-Gating Oral Nicotine Cans

In addition to and in conjunction with the devices and systems disclosed herein are methods of age-gating and more generally, preventing unauthorized access to, cans containing oral nicotine dosage forms. The disclosed methods are designed to prevent access to the oral nicotine dosage forms contained within the disclosed cans for underage or otherwise unauthorized users (including purchasers and consumers), while allowing access to users who are of proper age, or otherwise authorized for access.

According to some aspects, the disclosed methods include authenticating a user and either unlocking or declining to unlock a can, based on a result of the authentication. According to some aspects, the authentication may include collecting a user metadata, comparing the user metadata to a control data, determining a positive or negative authentication result based on the comparison. According to some embodiments, one or more, or all, of these steps may be performed by an external device such as an NFC or RFID reader. As used herein, “data” may refer to either a single datum or a plurality of data. As discussed above, the user metadata may include one or more of a purchase timestamp, name, address, email address, date of birth, user identification, driver license number, passport number, government ID number, age, and the like. The control data may include data configured to provide a comparison point to the user metadata. The control data may be obtained from or provided by a reliable, secure, and/or verified source, such as a government or regulatory agency or database, a law enforcement agency or database, an academic organization or publication, a medical facility or publication. The control data may include, for example, one or more of a name (e.g., such as from birth certificates, voter registration databases, etc.), an address, a date of birth or range of dates of birth, an age, an age range, a driver license number, a passport number, a government ID number, and the like. The control data may be stored in a physical database or a digital database, either at the point-of-sale or remotely. According to some embodiments, the control data may be stored in a memory of the external device, while in other embodiments, the control data may be stored on a remote server.

The comparison may include comparing the user metadata to the control data and, if the user metadata matches the control data, determining a positive authentication result. Conversely, if the user metadata does not match the control data, determining a negative authentication result. According to embodiments in which the control data is stored remotely, the comparison may involve transmitting and/or receiving the control data and/or the user metadata to or from a remote server.

According to some aspects, if the disclosed methods may include unlocking the can, if the authentication result is positive. Conversely, the disclosed methods may include taking no action, i.e., leaving the can in a locked state, if the authentication result is negative. According to some embodiments, the external device, such as the NFC or RFID reader, may transmit an unlocking signal to the radiofrequency component of the disclosed can upon determining a positive authentication result. According to some aspects, the unlocking signal may trigger unlocking of the can by any of the mechanisms disclosed herein. Alternatively or additionally, in embodiments in which the external device is equipped with unlocking means such as one or more of electrical nodes, an acoustic transducer, a puncturing tool, or the like, the external device may activate one or more of its own unlocking means upon determining a positive authentication result.

In a case in which the authentication result is negative, in some embodiments, external device may take no action, i.e., it may leave the can locked. Alternatively, or additionally, upon determining a negative authentication result, the external device may provide an alert as to the negative result, including one or more of a notification or image provided on a display, a light, a sound, or similar.

In a preferred embodiment, in which age gating is being performed, the user metadata may include a date of birth or an age of the user and the control data may include a present age threshold, an age range, a preset date of birth threshold, a date of birth range, or similar.

As shown in FIG. 20, the unlocking of the can 100 may including tapping, resting, contacting, or otherwise bringing the can 100 into proximity with external device 1500. According to some preferred embodiments, external device 1500 may include an NFC or RFID reader 1502 and the unlocking may involve bringing the can within a transmittal range of the NFC or RFID reader 1502. According to a preferred embodiment, the unlocking may include touching a portion of the can, e.g., the lid, containing the radiofrequency to the NFC or RFID reader. In a case where FIG. 20 depicts a circumstance where the NFC or RFID reader 1502 has determined a positive authentication result, according to an embodiment, the NFC or RFID reader may transmit an unlocking signal to the radiofrequency component of the disclosed can 100, resulting in conversion of the shape memory component from a second to a first shape, thereby unlocking the can.

As described below, the devices, systems, and methods can provide several significant advantages and benefits over other devices, systems, and methods for containing, securing, and age-gating dosage forms, such as oral nicotine dosage forms, currently available in the art. However, the recited advantages are not meant to be limiting in any way, as one skilled in the art will appreciate that other advantages may also be realized upon practicing the present disclosure. It will be appreciated, moreover, that other applications for the disclosed cans are also possible and considered to fall within the scope of the present disclosure.

Furthermore, those skilled in the relevant art will recognize that changes can be made to the described embodiments while still obtaining the beneficial results. It will also be apparent that some of the advantages and benefits of the described embodiments can be obtained by selecting some of the features of the embodiments without utilizing other features, and that features from one embodiment may be combined with features from other embodiments in any appropriate combination. For example, any individual or collective features of method embodiments may be applied to apparatus, product or system embodiments, and vice versa. Accordingly, those who work in the art will recognize that many modifications and adaptations to the embodiments described are possible and may even be desirable in certain circumstances, and are a part of the disclosure. Thus, the present disclosure is provided as an illustration of the principles of the embodiments and not in limitation thereof, since the scope of the invention is to be defined by the claims.

### LISTING OF DRAWING ELEMENTS

100 can
102 base
104 lid
106 storage cavity
108 locking mechanism
110 shape memory component
112 coil
114 channel
116 locking cavity
116a first locking cavity
116b second locking cavity
202 locking slot
402 tab
402a first tab
402b second tab
404 tab holder
502 hatch
702 locking protrusion
802 pistons
802a first piston
802b second piston
804 pressure chamber
804a first pressure chamber
804b second pressure chamber
806 pressure release valve or puncture location
900 locking state indicator
902 window
904 indicator portion
1102 radiofrequency component
1202 cover
1302 snap-on cover
1400 NFC enabled can
1402 NFC chip
1404 antenna
1406 shape memory component actuator
1500 External device
1502 NFC or RFID reader
1504 electrical nodes
1504a first electrical node
1504b second electrical node
1506 contact area
1602 electrical contacts
1602a first electrical contact
1602b second electrical contact
1604 flanges
1604a first flange
1604b second flange
1702 magnetic component
1704 electromagnetic coil
1802 transducer
1900 computer system
1902 bus
1904 processor
1906 instructions
1908 peripheral interfaces
1910 memory
1912 network interface
1914 input/output system
1916 communicative connection
1918 network
1920 remote device
1922 storage device
1924 display adapter
1926 input device
1928 display
1930 medium
2002 display
2004 power source
2006 outer body

What is claimed is:

1. A can for storage of oral nicotine dosage forms, comprising:
a base and a lid, together defining a storage cavity;
a locking mechanism comprising a shape memory component, the shape memory component comprising a coil and having a first shape and a second shape;
wherein the shape memory component is configured to maintain the can in a locked state in the second shape and to convert the can into an unlocked state in the first shape;
an NFC tag;
a shape memory component actuator electrically connected to the NFC tag and to the shape memory component,
wherein the coil is extended in the second shape and the coil is contracted in the first shape.

2. The can of claim 1, wherein the locking mechanism is configured to prevent removal of the lid in the locked state and is configured to allow removal of the lid in the unlocked state.

3. The can of claim 1, wherein the locking mechanism further comprises a rod having a first end and a second opposing end.

4. The can of claim 3, wherein the base comprises:
a first locking cavity in which the first end of the rod is received when the shape memory component is disposed in the second shape, and
a second locking cavity in which the second end of the rod is received when the shape memory component is disposed in the second shape.

5. The can of claim 4, wherein the first end of the rod does not extend into the first locking cavity when the shape memory component is disposed in the first shape, and
the second end of the rod does not extend into the second locking cavity when the shape memory component is disposed in the second shape.

6. The can of claim 3, wherein the can is a cylindrical can and the base comprises a locking slot extending entirely around a circumference of the can.

7. The can of claim 6, wherein the first end of the rod and the second end of the rod are received in the locking slot when the shape memory component is disposed in the second shape.

8. The can of claim 6, wherein the first end of the rod and the second end of the rod do not extend into the locking slot when the shape memory component is disposed in the first shape.

9. The can of claim 1, wherein the lid comprises a channel and the locking mechanism is disposed within the channel.

10. The can of claim 3, wherein the coil is disposed between the first end of the rod and the second end of the rod.

11. The can of claim 1, wherein the shape memory component comprises a shape memory alloy.

12. The can of claim 11, wherein the shape memory alloy comprises at least one of a copper-aluminum-nickel alloy or a nickel-titanium alloy.

13. The can of claim 1, further comprising a locking state indicator configured to visually indicate whether the can is in the locked state or the unlocked state.

14. The can of claim 13, wherein the locking state indicator comprises a window disposed in the lid configured to provide a view of a portion of the locking mechanism.

15. The can of claim 14, wherein the locking state indicator further comprises a first portion having a first pattern or a first color, and an indicator portion having a second pattern or a second color, wherein the first portion is visible in the window in the locked state and the indicator portion is visible in the window in the unlocked state.

16. A can system, comprising:
the can of claim 1, and
a plurality of dosage forms disposed within the storage cavity, wherein the plurality of dosage forms consist of oral nicotine dosage forms.

17. A method of unlocking the can of claim 1, comprising:
sending an unlocking signal to the NFC tag using an NFC reader;
receiving the unlocking signal using an antenna of the NFC tag;
providing electrical current to the shape memory component actuator upon receipt of the unlocking signal by the NFC tag;
providing at least one of heat or electrical current to the shape memory component using the shape memory component actuator; and
inducing a state change of the shape memory component from the second shape to the first shape to unlock the can.

18. A method of unlocking the can of claim 17, wherein the providing of the electrical current to the shape memory component actuator includes providing electrical current generated by the NFC tag upon receipt of the unlocking signal.

19. A method of unlocking the can of claim 18, wherein the providing of the electrical current to the shape memory component actuator further includes providing electrical current generated by at least one of a power source disposed within the can or the NFC reader.
